(19) United States
(12) Patent Application Publication
(10) Pub. No.: US 2004/0250398 A1
(43) Pub. Date: Dec. 16, 2004

(54) Recycling method and recycling system for the recycling method

(76) Inventors: Yoshihiro Morii, Kanagawa (JP); Satosu Souma, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/795,394

(22) Filed: Mar. 9, 2004

(30) Foreign Application Priority Data
Mar. 19, 2003 (JP) 2003-076188 (JP)

(51) Int. Cl. G03G 15/08

(52) U.S. Cl. 29/403.1

(57) ABSTRACT

A recycling system in which a toner used for images on paper sheets is recycled while the conventional recycling by producing recycled paper is performed, and which can thereby contribute to environmental protection more effectively. The recycling system has a developer removal section which has an information processing and communication functions, and which removes a developer attached to paper sheets used on the market, and accommodates the removed developer, and a developer processing section which has an information processing and communication functions, and which performs recycling processing on the developer accommodated in the developer removal section. The developer removal section makes a determination as to the need for recycling processing on the developer on the basis of the amount of accommodated developer, and transmits recycling processing request information to the developer processing section when determining that there is a need for recycling. The developer processing section performs recycling processing on the developer after receiving the recycling processing request information from the developer removal section.

### BACKGROUND OF THE INVENTION

1. Field of the Invention

The present invention relates to a recycling method for recovering a developer from products such as image forming apparatuses used on the market, used paper sheets, etc., and to a recycling system for the recycling method.

2. Description of the Background Art

In recent years, with growing interests in environmental problems, makers and other companies have proceeded to recover and recycle their products, etc., from the viewpoint of efficient use of resources, reduction in waste, reduction in cost, etc. Recycling methods are generally categorized as described below.

1) Private Reuse:

A recycling processing method in which a user using a product reuses a portion of the product, i.e., a component part or the like. For example, a case where a user using a copying machine which is a kind of image forming apparatus reuses a container containing a developer, i.e., a toner bottle, by refilling the bottle with the developer corresponds to this method. In this case, the container to be recycled is reused and, therefore, the value of the container is not reduced. Therefore, private reuse can be said to be a processing method which maximizes the environmental load reduction effect and minimizes the recycling cost.

2) Product Reuse:

A recycling processing method in which predetermined regeneration processing is performed on a product such as a copying machine recovered from the market after being used (hereinafter referred to as “recovered product”) to enable the recovered product to be used a “regenerated product”. In the case of this processing method, the environmental load reduction effect is markedly high since the most of the components of a product are directly reused.

3) Component Reuse:

A recycling processing method in which a component or a unit is taken out from a recovered product and is reused as a component or a unit in a new product. This method has a high environmental load reduction effect in that a component or a unit which is originally manufactured by applying a considerable amount of energy to processing can be provided without performing the manufacturing process.

4) Material Recycling:

A recycling processing method in which a recovered product is broken into unit materials from which regenerated materials to be used are obtained by certain processing. This method comprises a closed-loop material recycling method which enables use of a material in a product in the field to which the product from which the material has been obtained belongs, and an open-loop material recycling method which enables use of one material in a product in a field different from the field to which the product from which the material has been obtained belongs.

5) Reduction to Raw Material:

A recycling processing method in which a recovered product is broken down into materials and classification, etc., are performed on the materials to finally obtain raw materials to be reused. This method enables zero-waste recycling.

6) Energy Recovery:

A processing method in which a combustible material, e.g., a plastic used in a recovered product is effectively used as thermal energy by combustion for example.

Among the above-described processing methods, “1) Private Reuse” is most preferable in terms of environmental load reduction effect. The order of preference of the other methods is 2), 3), . . . , 6). Therefore, the important point in actual promotion of recycling by makers is how recycling is sustained by processing methods higher in rank.

In actuality, however, it is impossible to semipermanently continue processing by a processing method higher in rank, e.g., the processing method of the above-described “1) Private Reuse”. That is, the processing method must be abandoned after a certain time period. This is because the functions of a product themselves become obsolescent after a certain time period and not useful on the market or for users and the economical value of recycling the product by the processing method is lost.

In such a case, if recycling by a processing method higher in rank, e.g., “1) Private Reuse” recycling has been performed, one of the processing method “2)” and other subordinate methods is carried out. Recycling is performed for a certain time period by the subordinate processing method. When the recycled object becomes obsolescent, another of the subordinate processing methods is substituted. Progress is thus made in recycling. In recycling, processing by only one of the above-described methods “1) to 6)” does not suffice; all the processing methods must be carried out.

Also, in actuality, the processing methods “1) to 6)” must be carried out generally in parallel with each other because the stage of processing, i.e., one of the above-described processing methods “1) to 6)” is changed depending on the kind of product (e.g., copying machine) and because, even if recycling is limited to one kind of product, the stage of recycling processing is changed depending on components/units in the product.

A recycling processing method relating to this problem, e.g., one proposed in Japanese Patent Laid-Open No. 2000-181958 is known. In this conventional recycling method proposed, processing from a raw material stage to a disposal stage is precisely defined as a material flow to deliberately produce a recycled product using recycled parts.

Office machines such as printers, copying machines and facsimile machines are said to be an example of products for which recycling based on the above-described methods has been promoted. In the case of such office machines, however, used articles include supplies such as expendables. Typical examples of such supplies are developers including a toner and a carrier, and used paper sheets having images formed thereon. In recycling of such machines, therefore, it is very important to consider how such supplies are recycled as well as machine main bodies.

A method of processing for recycling a developer as a supply, e.g., one proposed in Japanese Patent Laid-Open No. 2001-3063 is known. According to this conventional recycling processing method proposed, a waste toner and a waste carrier are effectively utilized in ironworks by taking note of the fact that the toner and the carrier are fine particles. More specifically, a waste toner and a waste carrier are mixed with a mixer in a raw material to be sintered and this mixture material to be sintered is sintered by sintering equipment, thereby enabling iron powder in the waste toner and waste carrier mixed in the sintered raw material to be effectively utilized as an iron source. Also, part of a resin in the waste toner is combusted to be effectively utilized as a substitute for powder coke. Since the waste toner and waste carrier are sintered after being mixed in a raw material to be sintered, they can be easily handled without being scattered.

Methods of recycling processing on paper sheets used as supplies include production of recycled paper. Since documents written on used paper sheets are ordinarily confidential documents, used paper sheets are processed by shredding or dissolution and solidification processing in advance and the processed paper is regenerated into new paper sheets, cleaning tissue, etc. This processing method corresponds to the above-described “4) Material Recycling” processing method in the recycling processing methods classified as described above. With recycled paper, however, the paper quality problem exists presently, basically due to paper quality contamination of recycled paper caused by a toner attached to collected used paper. This problem is particularly serious in a case where high-quality paper is demanded.

On the other hand, a recycling apparatus for recycling used paper without forming ordinary recycled paper has already been proposed. This recycling apparatus operates in such a manner that a predetermined chemical solution is applied to used paper sheets, fibers in the paper sheets are thereby swollen to reduce the bonding strength of a toner, and the toner is maintained in pressure contact with a separating member while being heated and is thereby transferred to the separating member to be removed. This process is said to be more advantageous than ordinary paper recycling in that images are removed from the used paper sheets to enable the paper sheets to be recovered as paper sheets having the same quality as that of the original high-quality paper sheets.

The recycling processing method using this recycling apparatus (also referred to as “toner removing apparatus”) corresponds basically to the above-described “2) Product Reuse” processing method. Also from the above-described classification of recycling processing methods, recycling by the toner removing apparatus is said to be more advantageous than processing for forming ordinary recycled paper.

Recycling processing with this toner removing apparatus comprises several variations in implementation form. In a first implementation form, a user has the toner removing apparatus in his/her possession and performs regeneration processing by him-/herself when necessary. It is thought that the above-described recycling processing method in this form corresponds to the above-described “1) Private Reuse” processing method. Nevertheless, it actually corresponds to the above-described “2) Product Reuse” processing method according to the classification because regeneration processing itself occurs.

In a second implementation form, an organization or a person having the toner removing apparatus performs regeneration processing. For example, recycling in this form is proposed in Japanese Patent Laid-Open No. 2002-109021. Description will be made below of this form with reference to a drawing. Recycling in this form can be said to be a highly advantageous recycling processing method.

The above-described recycling processing method disclosed in Japanese Patent Laid-Open No. 2001-3063 is an effective environmental protection means. However, if a maker carries out the method as a center of recycling processing, i.e., major processing, there is a problem in terms of continuity of carrying out of the method. This problem resides in how economy is found right in an environmental protection activity. That is, in business activities, it is desirable to have an environmental protection activity while reducing the cost required for the activity. That is, it is desirable that an environmental protection activity and a profit making activity be based on a common axis and that the environmental protection activity itself be a source of profit for a company. The same can also be said in a recycling region which is part of the field of environmental protection activities. Carrying out recycling processing for pay, i.e., in such a manner as to obtain a profit, is more preferable than carrying out recycling processing for reverse pay. According to the recycling processing method disclosed in Japanese Patent Laid-Open No. 2001-3063, however, recycling processing is carried out for reverse pay, i.e., in such a form that money is paid from the toner/carrier supply side to the processing side using a toner or a carrier.

The reasons for this preference as seen in the technical aspect of recycling processing will be described below. First, in the above-described recycling processing method disclosed in Japanese Patent Laid-Open No. 2001-3063, the technical value added by a resin (binder resin) contained as a principal component in a toner is not sufficiently high. The resin component in the toner is used as a substitute for coke. However, only part of the resin component is used and a great portion thereof is gasified and processed by exhaust equipment in ironworks. Further, the blending ratio of a waste toner and a waste carrier in a sintering step is limited to 0.5% or less. This is because the toner resin component varies depending on the kind of toner and this variation influences the reduced condition of sintered ore, etc. A coating material is contained in a carrier. This coating material also influences the reduced condition or sintered ore, etc. This is also a reason for limitation of the blending ratio.

Second, if a developer is treated as an iron raw material, a toner and a carrier cannot be said to be an effective raw material because the amount of iron produced therefrom is not sufficiently large due to the above-mentioned limitation of the ratio of blending in the sintered material to 0.5% or less. Further, toners include those containing iron and those containing no iron. Even in those containing iron, the ion content is disadvantageously low, 50% or less. Therefore, the effectiveness in the case of use as an iron raw material is further reduced.

For these reasons, the functional effectiveness of a developer used as a raw material to be sintered is low and, therefore, the economical additional value of the developer is low. That is, a developer cannot be said to be a material indispensable and useful for execution of a sintering process.

On the other hand, there is a problem not yet solved with the above-described recycling processing method disclosed in Japanese Patent Laid-Open No. 2002-109021. The problem is that no method for processing a toner which is another supply for office machines has been proposed. That is, with respect to this recycling processing method, only the process that ends when a toner is separated from used paper sheets is mentioned. If separated toner is disposed of by landfilling, simple incineration or some other similar means, this processing method cannot be said to be reasonable from the viewpoint of environmental protection.

### SUMMARY OF THE INVENTION

An object of the present invention is to provide a recycling method which enables a steady recycling activity performing such recycling that any of developers containing all kinds of toner including iron toner and all kinds of carriers can have an additional economical value.

Another object of the present invention is to provide a recycling system in which paper recycling processing is performed on used paper sheets as in the past and recycling processing is also performed on a toner used for images on used paper sheets, and which thereby contributes to environmental protection more effectively.

In accordance with the present invention, a recycling method in which a developer is recovered from a product used on the market and is processed includes a developer recovery step of recovering the used developer from the market, and a developer regeneration step of making the developer recovered in the developer recovery step again usable on the market.

A recycling system in which used paper sheets used on the market are processed has a developer removal section which has an information processing function and a communication function, and which removes a developer attached to the used paper sheets, and accommodates the removed developer, and a developer processing section which has an information processing function and a communication function, and which performs recycling processing on the developer accommodated in the developer removal section. The developer removal section makes a determination as to the need for recycling processing on the developer on the basis of the amount of accommodated developer, and transmits recycling processing request information to the developer processing section when determining that there is a need for recycling. The developer processing section performs recycling processing on the developer after receiving the recycling processing request information from said developer removal section.

### BRIEF DESCRIPTION OF THE DRAWINGS

The above and other objects, features and advantages of the present invention will become more apparent from the following detailed description taken with the accompanying drawings in which:

FIG. 1 is a diagram showing the concept of an example of a conventional recycling system as a material flow from a raw material stage to a disposal stage;

FIG. 2 is a diagram showing the concept of another conventional recycling system;

FIG. 3 is a diagram showing the concept of a recycling method according to a first embodiment of the present invention;

FIG. 4 is a diagram showing a subordinate concept of the recycling method shown in FIG. 3;

FIG. 5 is a flowchart showing an example of a toner regeneration process according to a second embodiment of the present invention;

FIG. 6 is a flowchart showing an example of a toner regeneration process in which a new toner is mixed according to a third embodiment of the present invention;

FIG. 7 is a flowchart showing an example of a toner regeneration process in which a toner departing from a standard is reused according to a fourth embodiment of the present invention;

FIG. 8 is a flowchart showing another form of the toner regeneration process in which a new toner is mixed according to a fifth embodiment of the present invention;

FIG. 9 is a flowchart showing still another form of the toner regeneration process in which a new toner is mixed according to a sixth embodiment of the present invention;

FIG. 10 is a diagram showing the concept of recovery and regeneration of a two-component developer according to a seventh embodiment of the present invention;

FIG. 11 is a diagram showing a subordinate concept of recovery and regeneration of a two-component developer according to the same embodiment;

FIG. 12 is a flowchart showing a concrete process of recovery and regeneration of a two-component developer according to an eighth embodiment of the present invention;

FIG. 13 is a diagram showing the concept of recycling in a case where a recovery process is executed in a recycling center according to a ninth embodiment of the present invention;

FIG. 14 is a diagram showing the concept of a recycling system and method used according to the same embodiment;

FIG. 15 is a diagram showing the concept of a recycling in a case where a recovery process is performed in a recovery center and a recycling center according to the same embodiment;

FIG. 16 is a diagram showing the concept of a recycling method based on a signal from a developer regeneration process to a developer recovery process according to a tenth embodiment of the present invention;

FIG. 17 is a diagram schematically showing a system for execution of a developer recovery process and a developer regeneration process according to the same embodiment;

FIG. 18 is a diagram showing an example of an output produced by output means as recovered developer acceptance quality reference information according to the same embodiment;

FIG. 19 is a diagram showing the concept of a recycling method based on a signal from a developer regeneration process to a developer recovery process according to an eleventh embodiment of the present invention;

FIG. 20 is a diagram showing an example of an output produced by output means as recovered developer accepted amount information according to the same embodiment;

FIG. 21 is a diagram schematically showing a recycling system in which recycling information management based on a signal from a developer recovery process is performed according to a twelfth embodiment of the present invention;

FIG. 22 is a diagram showing the basic concept of a recycling system according to a thirteenth embodiment of the present invention;

FIG. 23 is a diagram showing a subordinate concept of a recycling system according to a fourteenth embodiment of the present invention;

FIG. 24 is a diagram showing the entire construction of an example of a toner removing apparatus according to the same embodiment;

FIG. 25 is a diagram showing the basic concept of a recycling system in which a developer secondary accommodation section is provided in a developer removal section according to a fifteenth embodiment of the present invention;

FIG. 26 is a diagram showing the basic concept of a recycling system in which a recovery center is provided as a developer removal section according to a sixteenth embodiment of the present invention;

FIG. 27 is a diagram showing the basic concept of a recycling system in which a recovered toner is used in sintering according to a seventeenth embodiment of the present invention;

FIG. 28 is a diagram showing the basic concept of a recycling system in which a recovered toner is used in granulation/forming according to an eighteenth embodiment of the present invention;

FIG. 29 is a diagram showing the concept of a recycling system according to a nineteenth embodiment of the present invention; and

FIG. 30 is a flowchart showing another form of the toner regeneration process reusing a toner departing from a standard according to the same embodiment.

### DESCRIPTION OF THE PREFERRED EMBODIMENTS

Conventional arts will be described with reference to the drawings before description of the present invention.

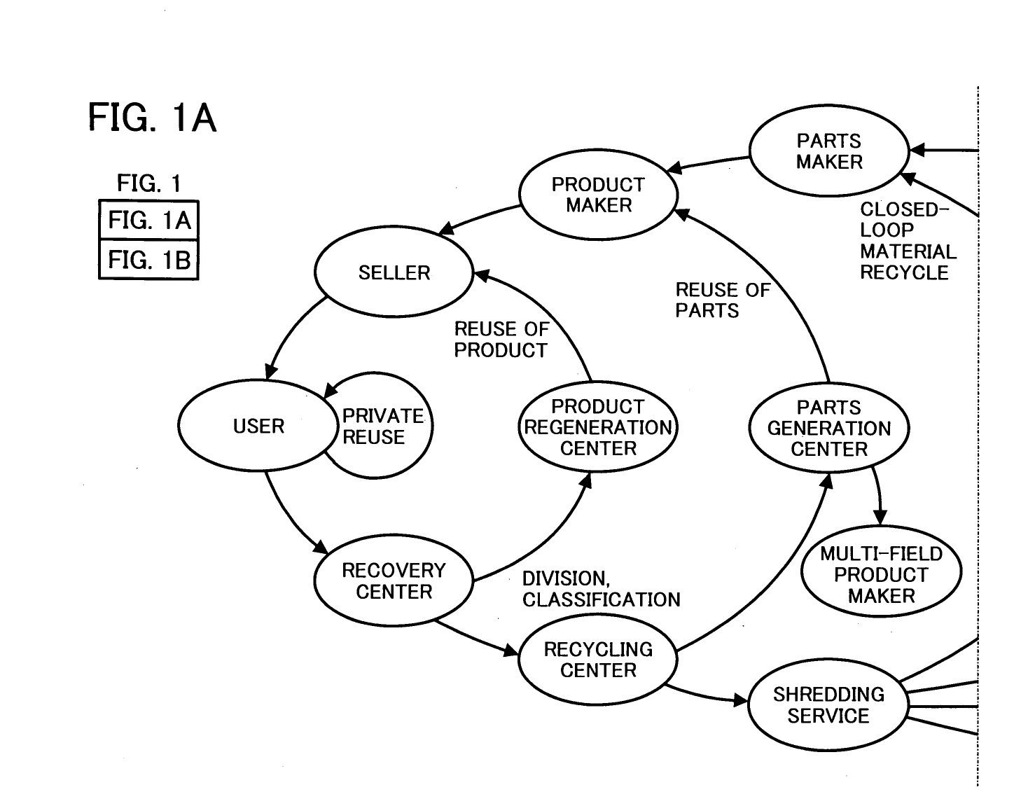

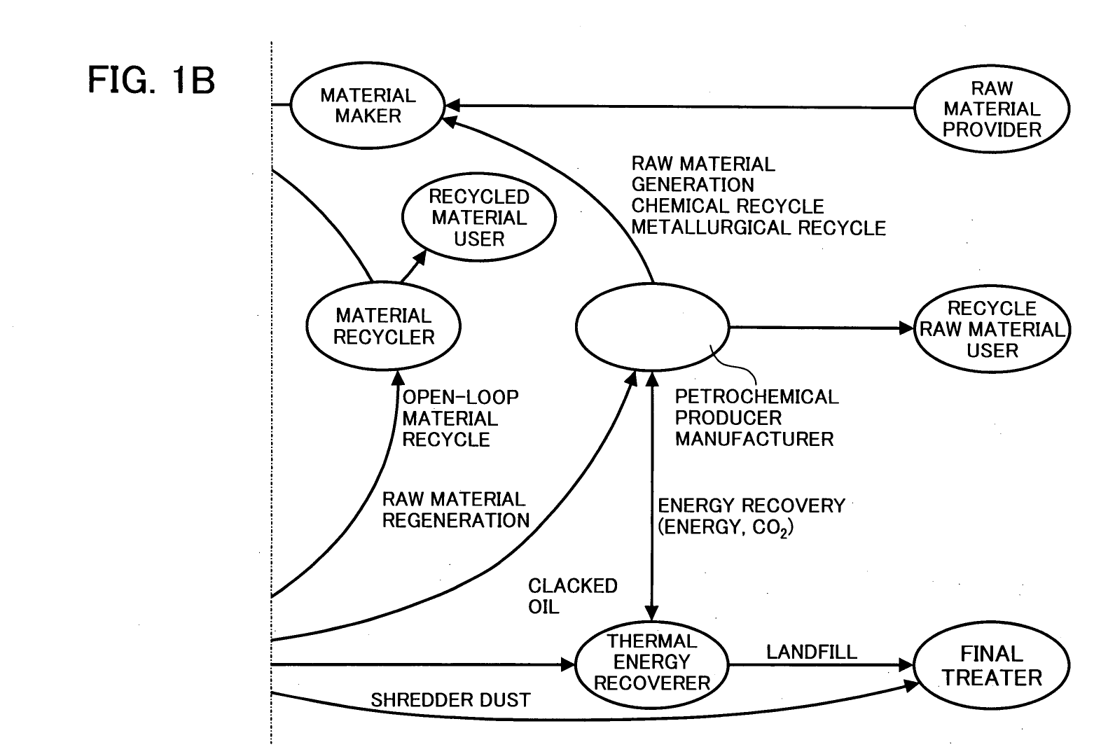

FIG. 1 schematically shows the recycling system disclosed in Japanese Patent Laid-Open No. 2000-181958. That is, the concept of precisely forming a material flow representing processing from a raw material stage to a disposal stage and performing programmed production of a recycled product using recycled parts.

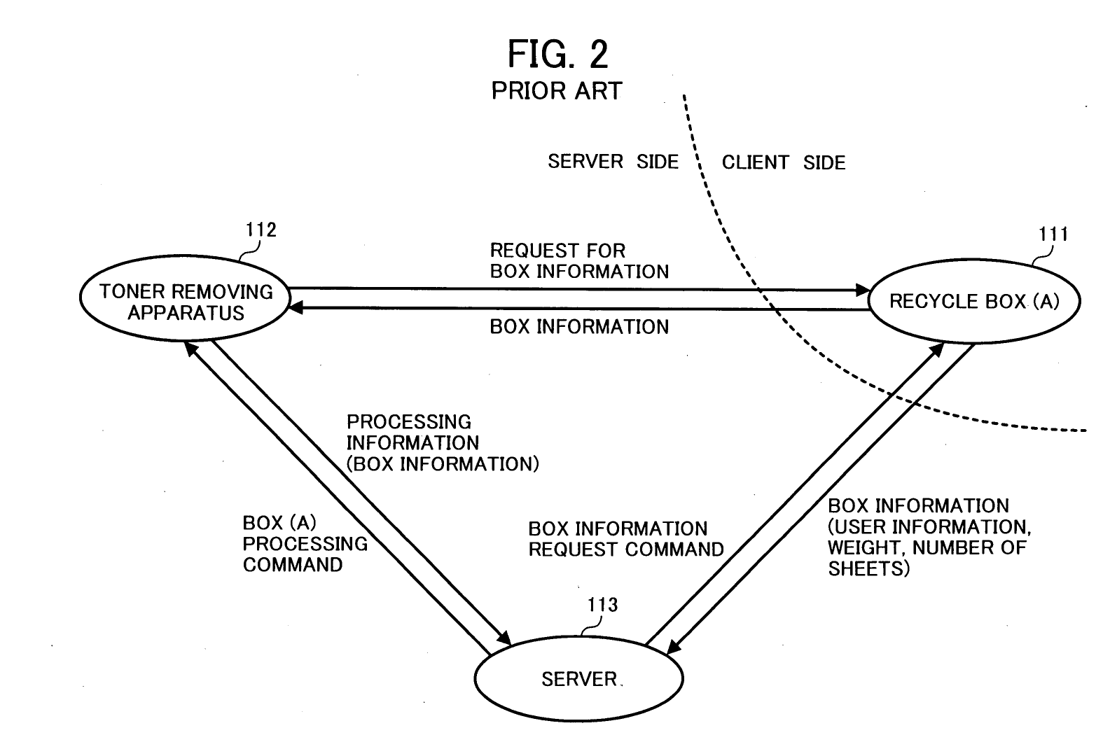

FIG. 2 schematically shows the recycling system disclosed in Japanese Patent Laid-Open No. 2002-109021. In this system, as illustrated, a server 113 performs management of the recycling system for recycling used paper sheets. A recycling box 111 provided in a customer's place collects used paper sheets and transmits information on the collection to the server 113 via a network. A toner removing apparatus 112 is mounted on a mobile recovery satellite (processing vehicle). The server 113 determines recycling processing on the basis of the collection information in the recycling box 111 and instructs the recovery satellite to perform the recycling processing. The recovery satellite recovers the recording medium in the recycling box 111 and performs recycling processing by using the toner removing apparatus 112, and resells the recovered medium.

Embodiments of the present invention will be described in detail with reference to the drawings.

### 1st Embodiment

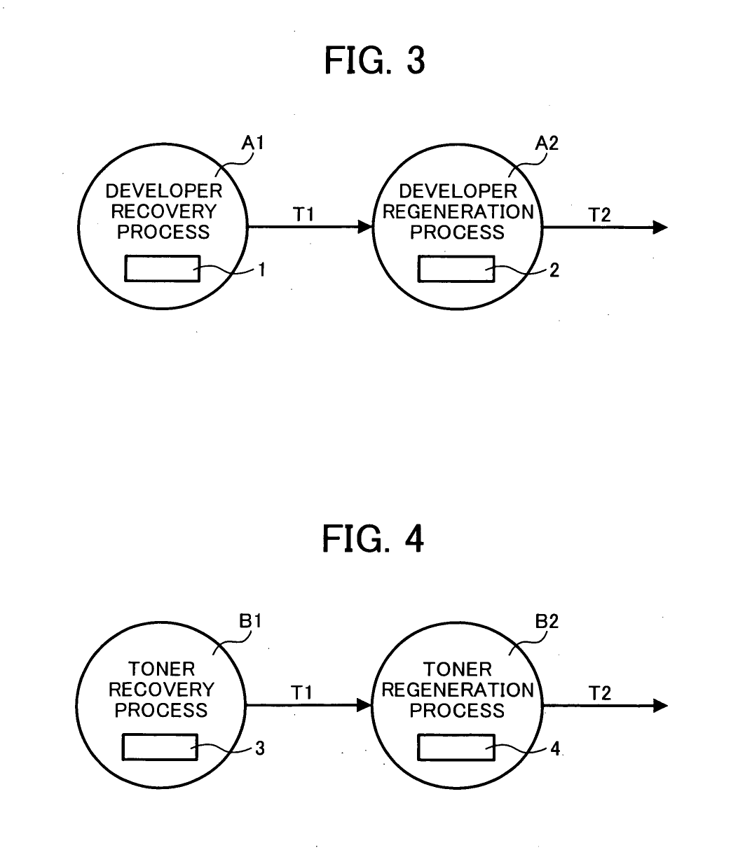

FIG. 3 shows the concept of a recycling method according to this embodiment. In this recycling method, a developer is recovered from the market in a developer recovery process A1. In the developer recovery process A1, the developer is recovered as recovered developer T1 by a developer recovery section 1. In a case where the product from which the developer T1 is recovered is an electrophotographic image forming apparatus, the recovered developer T1 corresponds to a toner or a carrier remaining in the product, i.e., in the apparatus, when the apparatus is recovered after use, or a collection of the toner or carrier as a supply recovered separately from the apparatus main body. The collected recovered developer T1 is delivered to a developer regeneration process A2, regenerated by a developer regeneration section 2 and, thereafter, again used as regenerated developer T2 on the market.

The developer recovery process A1 and the developer regeneration process A2 performed by the developer recovery section 1 and the developer regeneration section 2 may be executed as separate processes in one factory. However, in consideration of recovery of the developer widely distributed on the market, it is desirable from the viewpoint of physical distribution efficiency to provide the developer recovery section 1 and the developer regeneration section 2 respectively on different bases and to separately perform the developer recovery process A1 and the developer regeneration process A2. It is not necessary to perform each process at only one base. For example, the recovered developer T1 may be delivered from a plurality of places where the developer recovery process A1 is performed to a particular place for the developer regeneration process A2. In such a case, the developer recovery section 1 may be provided on each of a plurality of bases, and the developer regeneration section 2 may be provided on one base.

Since full use is made of the recovered developer T1 as the regenerated developer T2, full use can be made of the essential function of the developer after recycling. Thus, full use can be made without reducing the functional efficiency as in the problem with the above-described art disclosed in Japanese Patent Laid-Open No. 2001-3063. For the same reason, full use of the function can be made basically regardless of all types of toner (an iron type, a plastic type, etc.)

### 2nd Embodiment

FIG. 4 shows an example of a recycling method of this embodiment in a case where a developer to be recovered is a toner. As shown in FIG. 4, a recovered toner T3 recovered in a toner recovery process B1 is regenerated as regenerated toner T4 in a toner regeneration process B2. In this case, the toner is recovered by toner recovery means 3 in the toner recovery process B1, and is regenerated by toner regeneration means 4 in the toner regeneration process B2.

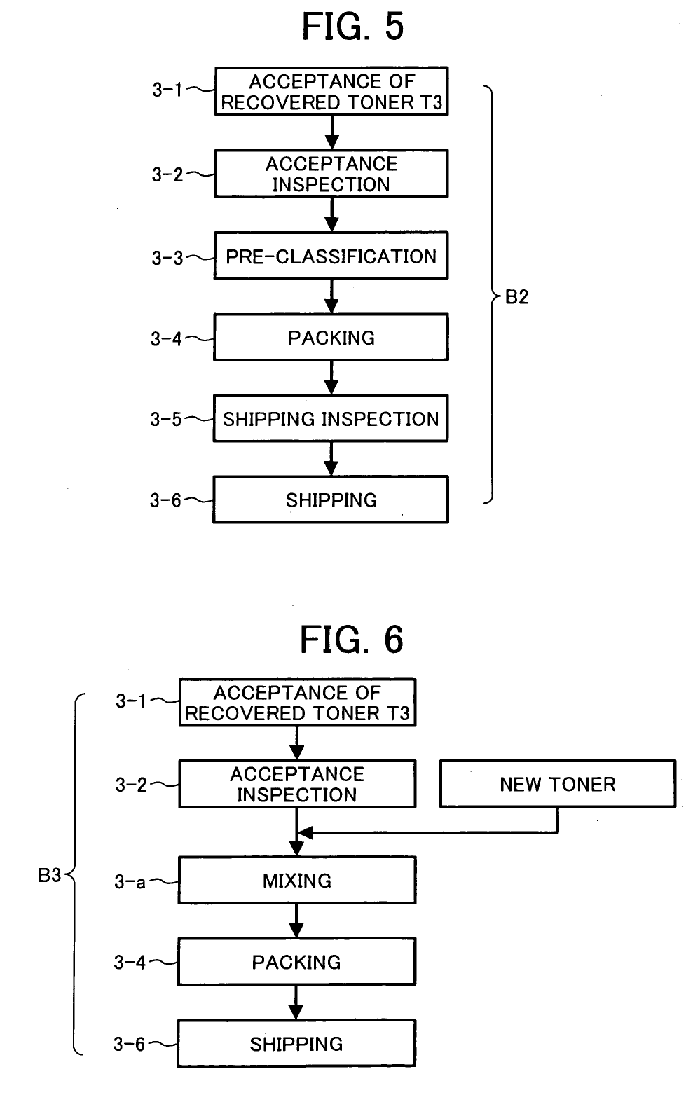

FIG. 5 shows the process of regenerating the toner as the toner regeneration process B2 according to the recycling method shown in FIG. 4. This regeneration process is performed in steps described below. In STEP 3-1, toner T3 to be recovered is accepted (recovered). In STEP 3-2, acceptance inspection is performed. As this acceptance inspection, an inspection in accordance with an acceptance criterion set in advance is made. For example, an inspection as to whether or not dust or the like is contained is performed by a desired inspection means. In STEP 3-3, pre-classification is performed. This step is performed for the purpose of removing a portion of the recovered toner T3 having a value smaller than a prescribed value due to wear (abrasion) on the market or removing dust or the like contained in the recovered toner T3. This classification is executed by a well-known means such as pneumatic classification conventionally used.

In STEP 3-4, packing of the recovered toner T3 in a container is performed. In STEP 3-5, an inspection for checking components in the packed toner and a shipping inspection for checking the amount of packing or the like are performed. In STEP 3-6, the toner packed in the container and checked by the delivery inspection is shipped as regenerated toner T4 (product) to the market.

STEPs 3-2, 3-3, and 3-5 are not absolutely necessary conditions. They may be inserted in the toner regeneration process if necessary according to variations in conditions such as kinds of toner. Description or explanation of STEPs 3-2, 3-3, and 3-5 will not be repeated in the explanation of other embodiments and drawings given below. However, it is assumed that in relation to the conditions under which these steps are required, recycling steps substantially the same in detail as the steps described with reference to FIG. 5 are performed while objects to be recovered are changed.

### 3rd Embodiment

In the above-described second embodiment, only the recovered toner T3 is used in the toner regeneration step. However, a newly produced toner (hereinafter referred to as “new toner”) T5 may be mixed in the regenerated toner as in this embodiment. The mixing ratio of this new toner T5 (equal to or higher than 0% and lower than 100%) is set according to the characteristics of the toner. FIG. 6 shows a toner regeneration process B3 in which a STEP 3-a of mixing the new toner T5 is added before STEP 3-4 in the process shown in FIG. 5. In STEP 3-a, the recovered toner T3 and the new toner T5 produced in a toner factory are mixed.

This STEP 3-a (mixing) may be removed and the recovered toner T3 and the new toner T5 may be mixed and packed in STEP 3-4 (packing). However, in consideration of the uniformity of the recovered toner T3 and the new toner T5 in the container after packing, it is desirable that the recovered toner T3 and the new toner T5 be mixed in advance by a mixing means such as mixer in STEP 3-a. The process may alternatively be such that the STEP 3-a (mixing) is removed and the uniformity of the recovered toner T3 and the new toner T5 in the container (no shown) after mixing and packing is improved, for example, by vibrating the container.

### 4th Embodiment

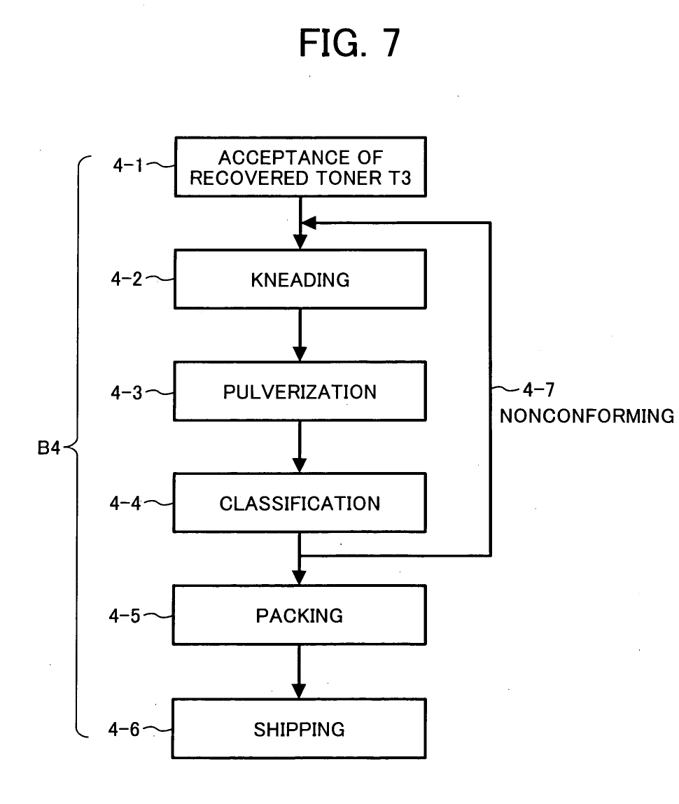

FIG. 7 shows another toner regeneration process B4 in the case of toner recycling. That is, in the toner regeneration process B4 in this embodiment, the recovered toner T3 is accepted in STEP 4-1; kneading is performed in STEP 4-2; pulverization is performed in STEP 4-3; classification for selecting only particles of the desired size by pneumatic classification means or the like is performed in STEP 4-4; packing is performed in STEP 4-5; and shipping is performed in STEP 4-6. These steps are basically the same as those in a pulverization process of the conventional art for producing new toner T5. However, while a toner raw-material is kneaded in STEP 4-2 in the case of the newly produced toner, the recovered toner T3 is kneaded in this embodiment.

A feature of this embodiment is as described below. In the second and third embodiments, a portion of the recovered toner T3 having a size smaller than the standard size as a result of wearing is removed in the pre-classification step. In this embodiment, the recovered toner T3 is kneaded again and, therefore, there is no need to discard a nonconforming portion, and the toner can be again made uniform in the desired size. Also in this embodiment, classification is performed in STEP 4-4. However, the toner removed in this step can be recharged in a recharge step provided as STEP 4-7 in this embodiment before kneading of the next lot (STEP 4-2), thus making full use of the toner.

### 5th Embodiment

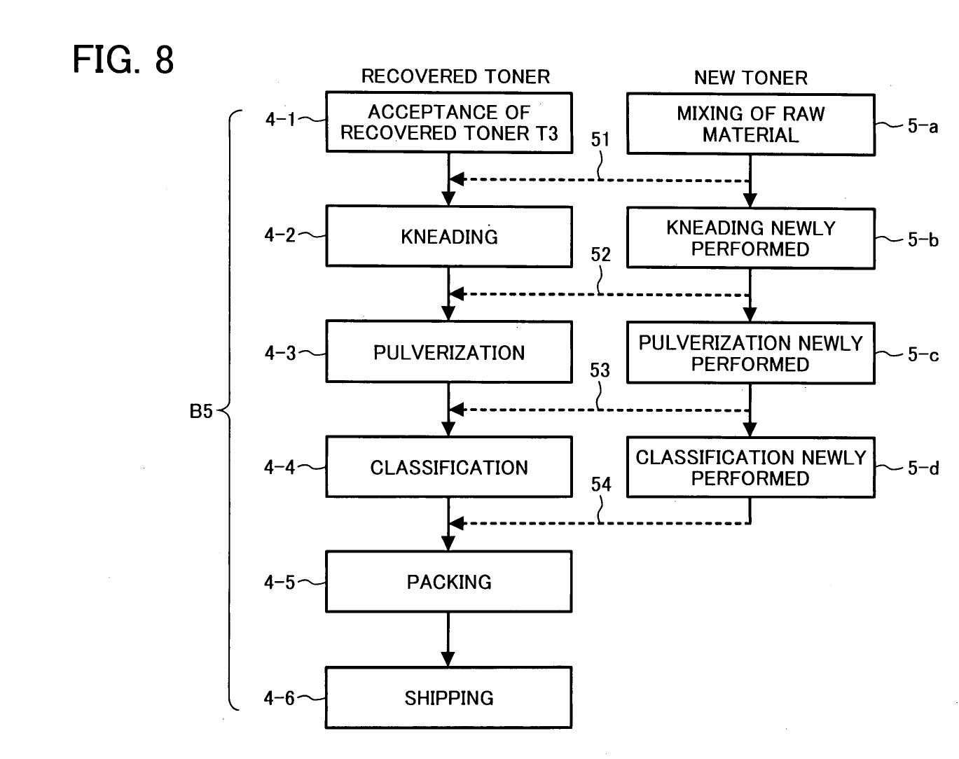

FIG. 8 shows still another toner regeneration process B5 in the case of toner recycling. That is, the toner regeneration process B5 in this embodiment is an example of application of the toner regeneration process B4. The contents of FIG. 8 from STEP 4-1 to STEP 4-6 are the same as those of FIG. 7, and the corresponding description will not be repeated. A feature of this embodiment resides in that steps described below are executed in parallel with STEPs 4-1 to 4-6. That is, kneading of a new raw material (new toner T5) is performed in STEP 5-a; kneading is newly performed in STEP 5-b; and pulverization is newly performed in STEP 5-c; and toner classification is newly performed in STEP 5-d. These STEPs 5-a to 5-d are steps for production of a new toner according to the conventional pulverization process. In this embodiment, however, STEPs 5-a to 5-d are selectively performed according to the characteristics of the regenerated toner.

More specifically, a selection can be made from four patterns: a case (indicated by reference numeral 51 in the flowchart) where after execution of kneading of a raw material (new toner T5) in STEP 5-a the new toner T5 kneaded in STEP 5-a is used in kneading in STEP 4-2; a case (indicated by reference numeral 52 in the flowchart) where after execution of kneading of the new toner T5 newly performed in STEP 5-b the new toner T5 kneaded in STEP 5-b is used in pulverization in STEP 4-3; a case (indicated by reference numeral 53 in the flowchart) where after execution of pulverization of the new toner T5 newly performed in STEP 5-c the new toner T5 pulverized in STEP 5-c is used in classification in STEP 4-4; and a case (indicated by reference numeral 54 in the flowchart) where after execution of classification of the new toner T5 newly performed in STEP 5-d the new toner T5 classified in STEP 5-d is used in packing in STEP 4-5.

By these steps, the new toner T5 can be mixed in the recovered toner T3 as desired. In each of the flows indicated by reference numerals 51 to 54 in the flowchart, a mixing step (not shown) for mixing of a recovered toner portion and a new toner portion may be provided and mixing may be performed in the mixing step by making use of a mixer or the like. The description of the mixer or the like will not be repeated with respect to the recovered toner portion and the new toner portion in the descriptions of other embodiments below. However, the corresponding mixing is performed under the same conditions as those of this embodiment or the third embodiment.

### 6th Embodiment

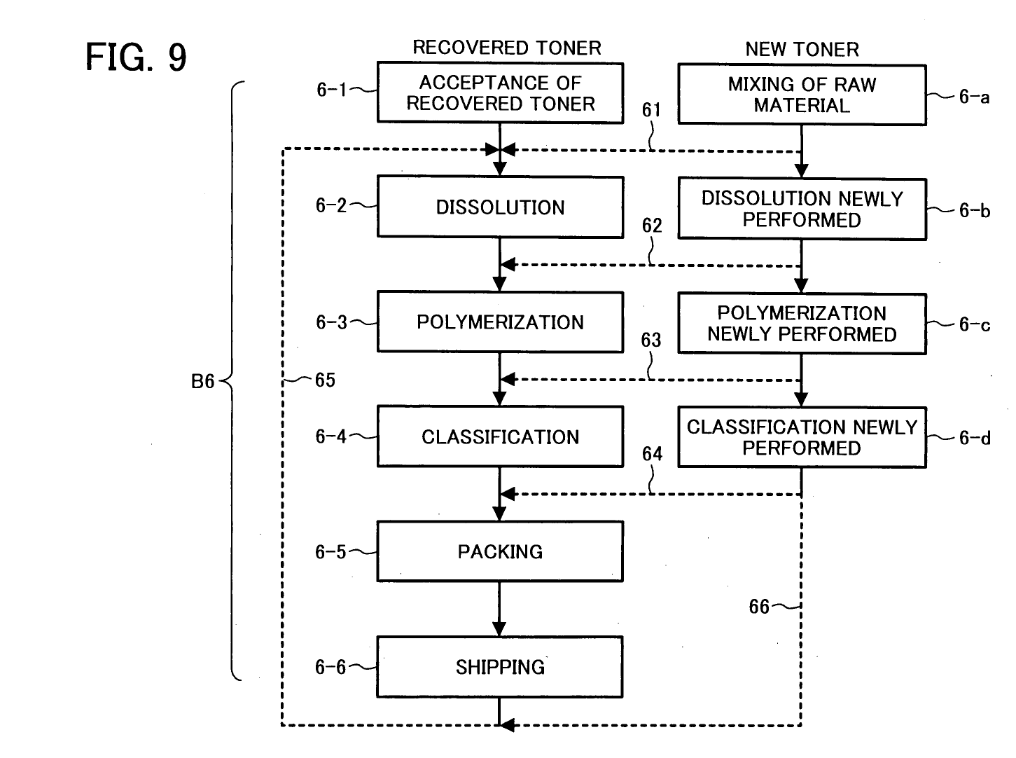

FIG. 9 shows still another toner regeneration process B6 in the case of toner recycling. That is, in the toner regeneration process B6 in this embodiment, effective use is made of polymerization which is a known technique for toner production. In the toner regeneration process B6, the recovered toner is accepted in STEP 6-1; dissolution is performed in STEP 6-2; polymerization is performed in STEP 6-3; classification is performed in STEP 6-4; packing is performed in STEP 6-5; and shipping is performed in STEP 6-6. In parallel with these steps, steps described below are performed by using a new toner material.

Mixing of a new raw material is performed in STEP 6-a; dissolution and kneading are newly performed in STEP 6-b; polymerization is newly performed in STEP 6-c; and toner classification is newly performed in STEP 6-d. STEPs 6-a to 6-d are selectively performed as desired according to the characteristics of the regenerated toner. In some case, STEPs 6-a to 6-d are not performed, while only STEPs 6-1 to 6-6 are executed.

More specifically, a selection can be made from four patterns: a case (indicated by reference numeral 61 in the flowchart) where after execution of kneading of a raw material (new toner T5) in STEP 6-a the raw material is mixed in the recovered toner accepted in STEP 6-1 and an advance is then made to STEP 6-2 for dissolution of the recovered toner T3; a case (indicated by reference numeral 62 in the flowchart) where after execution of dissolution of the new toner T5 newly performed in STEP 6-b the recovered toner T3 after dissolution in STEP 6-2 and new toner T5 are mixed and an advance is then made to STEP 6-3 for polymerization; a case (indicated by reference numeral 63 in the flowchart) where after execution of polymerization of the new toner T5 newly performed in STEP 6-c the recovered toner T3 after polymerization in STEP 6-3 and the new toner T5 are mixed and an advance is then made to STEP 6-4 for classification; and a case (indicated by reference numeral 64 in the flowchart) where after execution of classification of the new toner T5 newly performed in STEP 6-d the recovered toner T3 after classification in STEP 6-4 and the new toner T5 are mixed and an advance is then made to STEP 6-5 for packing. Effective use can be made of nonconforming portions removed in STEPs 6-4 and 6-d by performing steps of charging the nonconforming portions into a regeneration lot in the dissolution step, i.e., STEP 6-2, which charging steps are indicated by reference numerals 65 and 66 in the flowchart.

### 7th Embodiment

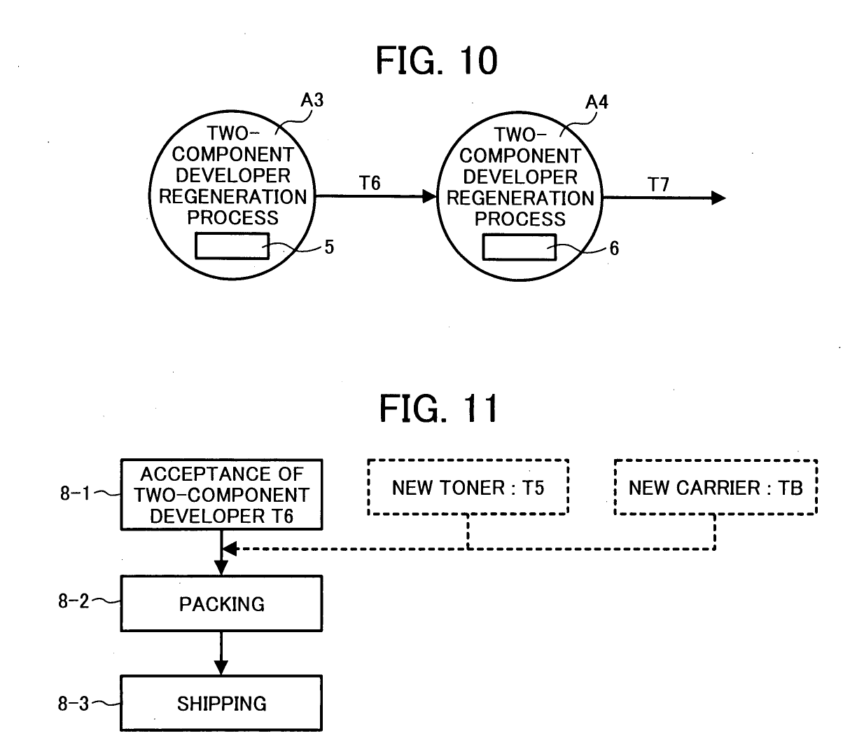

FIG. 10 shows an example of a recycling method according to this embodiment in a case where a developer to be recovered is a two-component developer in which a toner and a carrier are mixed. In this method, a recovered two-component developer T6 recovered in a two-component developer recovery process A3 is regenerated in a two-component developer regeneration process A4. In the two-component developer recovery process A3, the two-component developer T6 is recovered by two-component developer recovery means 5. In the two-component developer regeneration process A4, regeneration processing is performed by two-component developer regeneration means 6 to obtain a regenerated two-component developer T7.

FIG. 11 shows steps of regenerating the two-component developer in the two-component developer regeneration process A4. Referring to FIG. 11, the two-component developer T6 is accepted in STEP 8-1; packing is performed in STEP 8-2; and shipping is performed in STEP 8-3. In packing in STEP 8-2, toner T5 newly produced or carrier T8 newly produced may be mixed. The mixing ratio of the toner or the carrier (equal to or higher than 0% and lower than 100%) may be set according to the characteristics of the two-component developer T6.

### 8th Embodiment

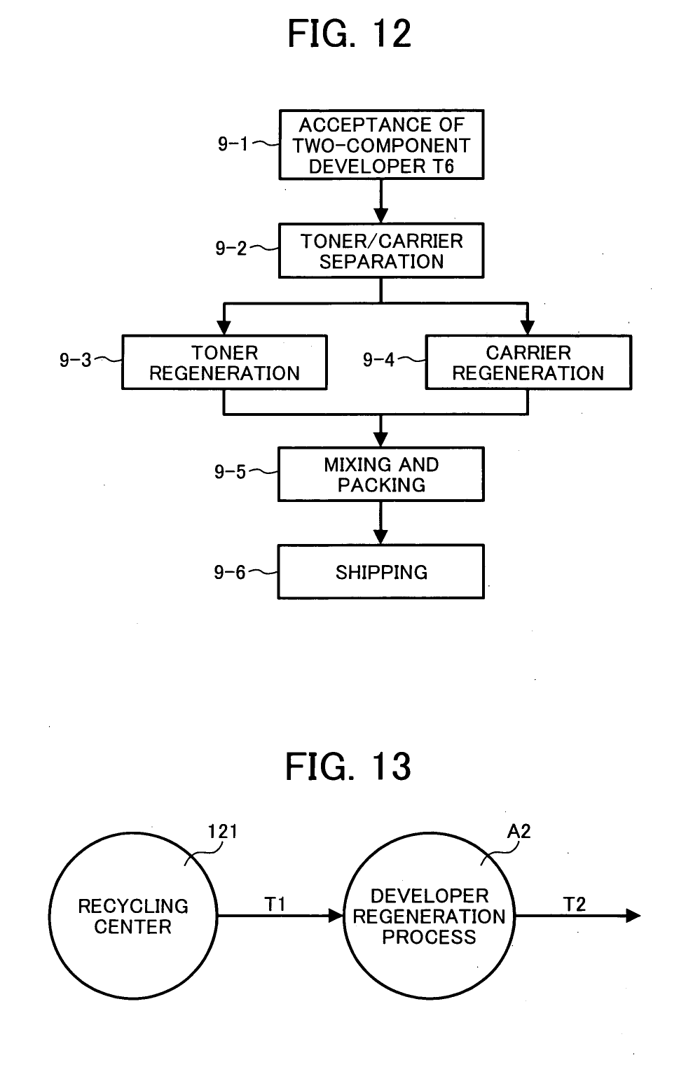

FIG. 12 shows a recycling method according to this embodiment in a case where a developer to be recovered is a two-component developer in which a toner and a carrier are mixed. As shown in FIG. 12, a recovered two-component developer T6 is accepted in STEP 9-1; separation is performed in STEP 9-2; regeneration of separated materials is performed in STEPs 9-3 and 9-4; mixing and packing are performed in STEP 9-5; and shipping is performed in STEP 9-6. A feature of this embodiment resides in that the recovered two-component developer T6 is separated into the toner and the carrier by separation in STEP 9-2 using a well-known pneumatic classification means or the like, the toner and the carrier after separation are respectively regenerated in STEPs 9-3 and 9-4, and the toner and the carrier are again mixed and packed in STEP 9-5. In the case of the toner after separation, regeneration processing may be performed by using the steps in the above-described second to fifth embodiments.

### 9th Embodiment

FIG. 13 shows a recycling method according to this embodiment in a case where the developer recovery section 1 in the first embodiment is a recycling center 121. In the method of this embodiment, a used developer is collected at the recycling center 121. The used developer comprises the recovered toner T3 and the recovered two-component developer T6 in the second to eighth embodiments.

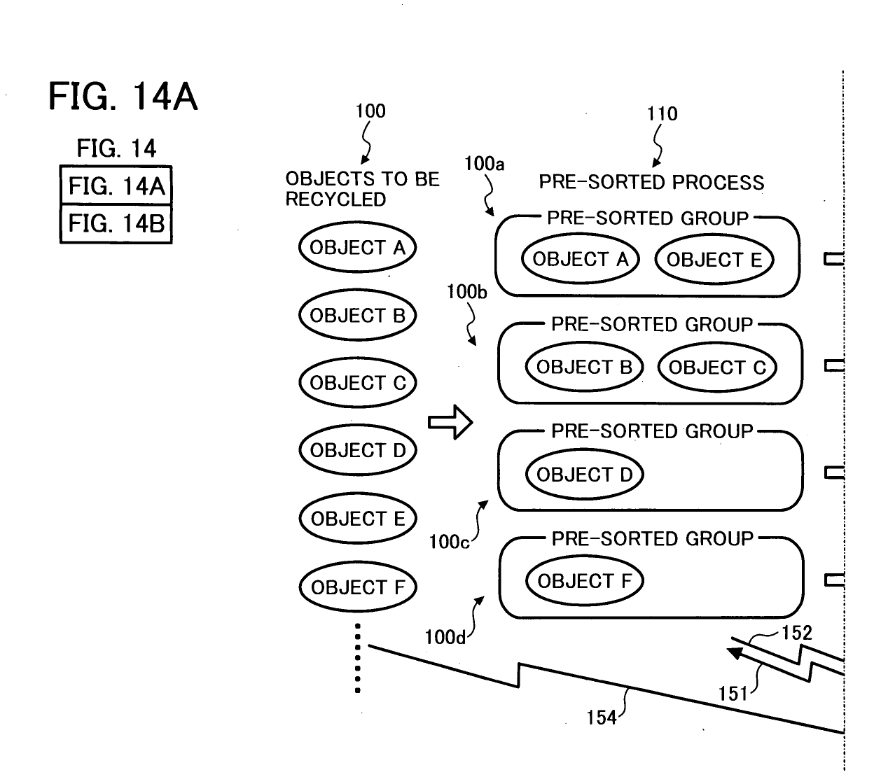

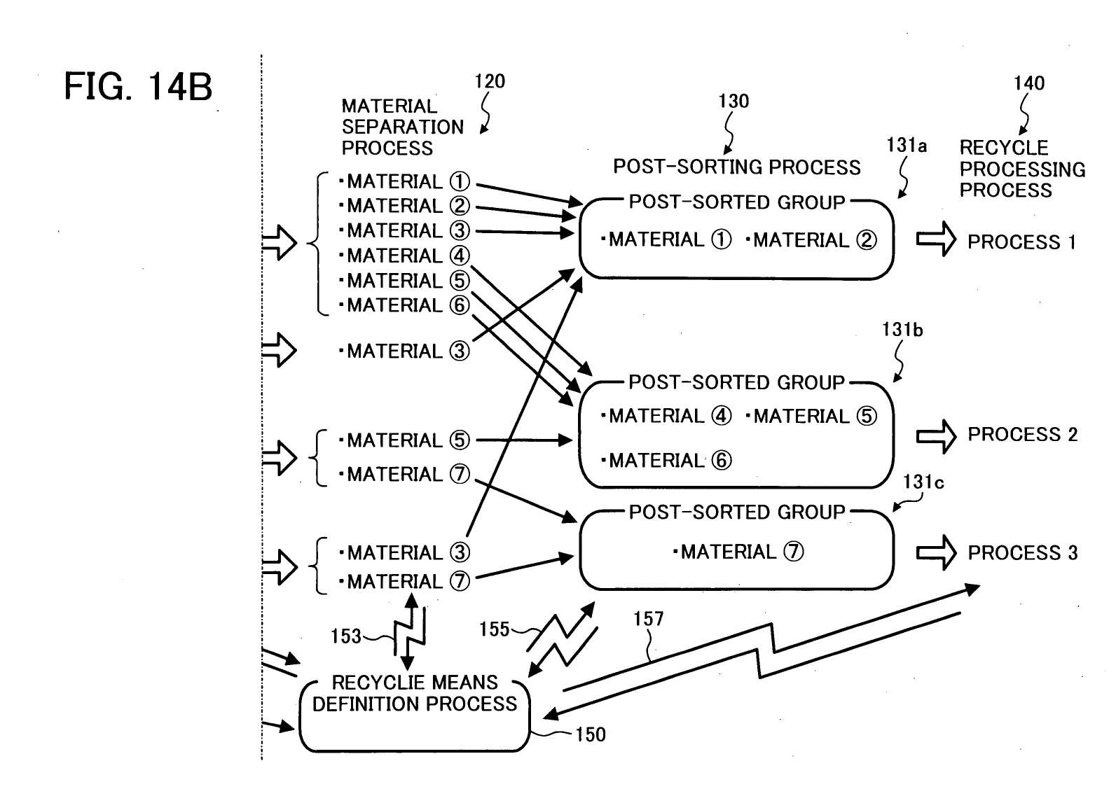

At the recycling center 121, various used articles, used product main units, used supplies, etc., are collected as well as the developer. The main functions of the recycling center 121 are to disassemble and separate collected articles. More specifically, at the recycling center 121, disassemble and separation of connected articles are performed in the system shown in FIG. 14, and the developer including a toner among the various articles is collected while being separated from the others.

As shown in FIG. 14, at the recycling center 121, object information 154, pre-sorting information 151 and 152, material separation information 153, post-sorting information 155 and recycling processing information 157 are exchanged between recycling means 150, objects 100 to be recycled, a pre-sorting process 110, a material separation process 120, a post-sorting process 130 and recycling processing processes 140 through communication means (not shown).

Objects 100 to be recycled including a plurality of objects A, B . . . are sorted into a plurality of pre-sorted groups 100a to 100d in the pre-sorting process 110, and the objects in each group are separated on a material-by-material basis in the material separation process 120. In the post-sorting process 130, the materials separated in the material separation process 120 are sorted with respect to different recycling processes to form post-sorted groups 131a to 131c, and the post-sorted groups 131a to 131c are respectively supplied to the recycling processing processes 140 to perform processes 1, 2, 3 corresponding to the materials. Thus, in the recycling center 121, the developer can be recovered by being treated as one of materials to be sorted.

For these processes, a communication section to which information on the objects to be recycled is input, and a well-known set of a CPU, a RAM and a ROM for preparing first sorting conditions for sorting the objects to be recycled on the basis of disassembling/separating operation conditions, second sorting conditions for sorting on the material-by-material basis, and third sorting conditions for sorting on the basis of kinds of recycling processing subsequently performed are provided. The first sorting conditions, the second sorting conditions and the third sorting conditions are transmitted from the communication section to the places where sorting operations are performed.

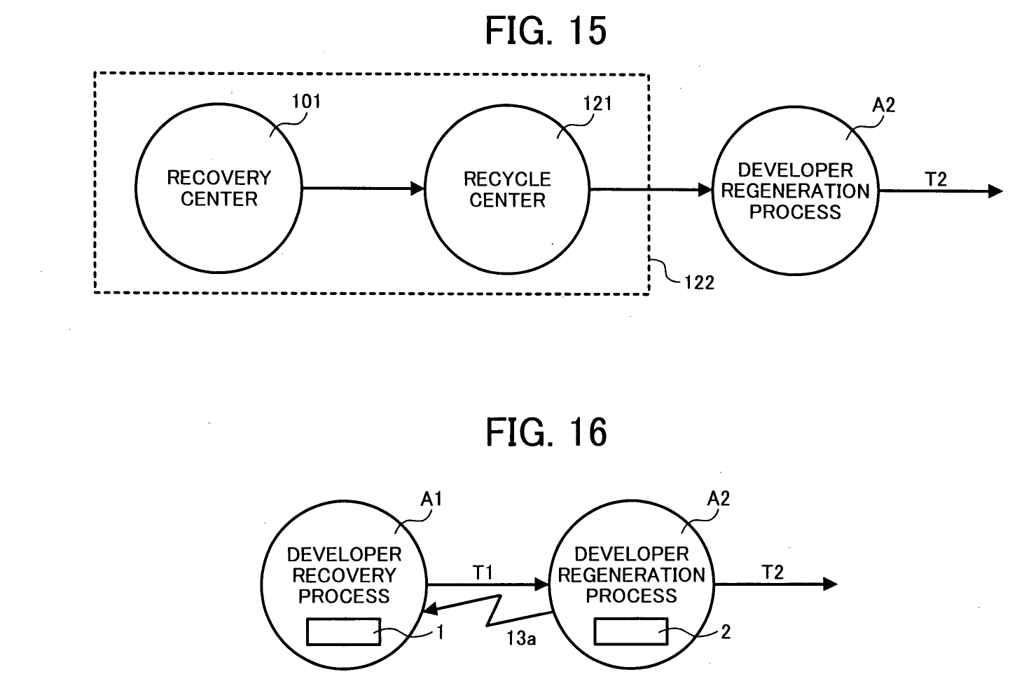

In the system shown in FIG. 13, only the recycling center 121 recovers the developer. Alternatively, as shown in FIG. 15, a developer recovery process may be executed by a developer recovery section 122 formed by combining a recovery center 101 which recovers the developer from the market and a recycling center 121 which separates the developer. Also in the system shown in FIG. 15, the working processes of the recycling center 121 described above with reference to FIG. 14 can be performed in common.

### 10th Embodiment

This embodiment will be described with respect to examples of various means for information communication for smoothly performing the recycling process in each of the above-described embodiments. FIG. 16 shows an example of information communication for satisfying a quality condition. For production of a regenerated developer of good quality in the developer regeneration section 2 in the developer regeneration process A2, conditions for certain quality are required for the developer recovery section 1 in the developer recovery process A1.

Preferably, information on such conditions is communicated as recovered developer acceptance quality reference information 13a from the developer regeneration section 2 in the developer regeneration process A2 to the developer recovery section 1 in the developer recovery process A1. In the recovered developer acceptance quality reference information 13a, a required criterion is individually presented with respect to each of different kinds of developer and each of different kinds of toner. The information itself is collectively transmitted. For example, an allowable amount of a foreign material corresponds to a content of the recovered developer acceptance quality reference information 13a.

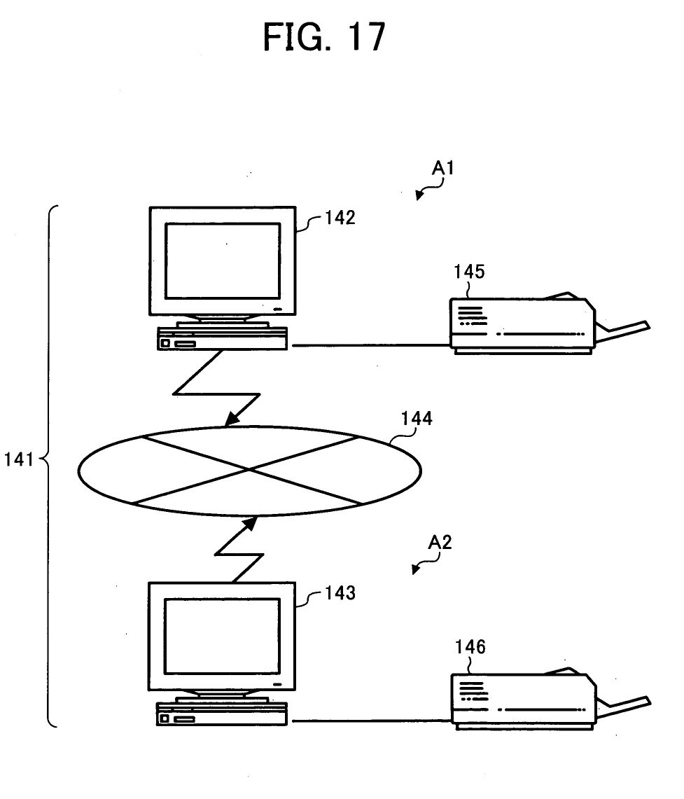

FIG. 17 shows an example of a method of communicating the recovered developer acceptance quality reference information 13a. As shown in FIG. 17, a communication system 141 includes personal computers 142 and 143 provided as communication means for the developer recovery process A1 and the developer regeneration process A2 and having communication functions. Portable information terminals having communication functions may substitute for the personal computers 142 and 143. These personal computers or portable information terminals are connected to a network 144 such as the Internet or a LAN so as to be able to communicate with each other. Thus, the recovered developer acceptance quality reference information 13a can be easily communicated from the developer regeneration process A2 to the developer recovery process A1 by well-known means.

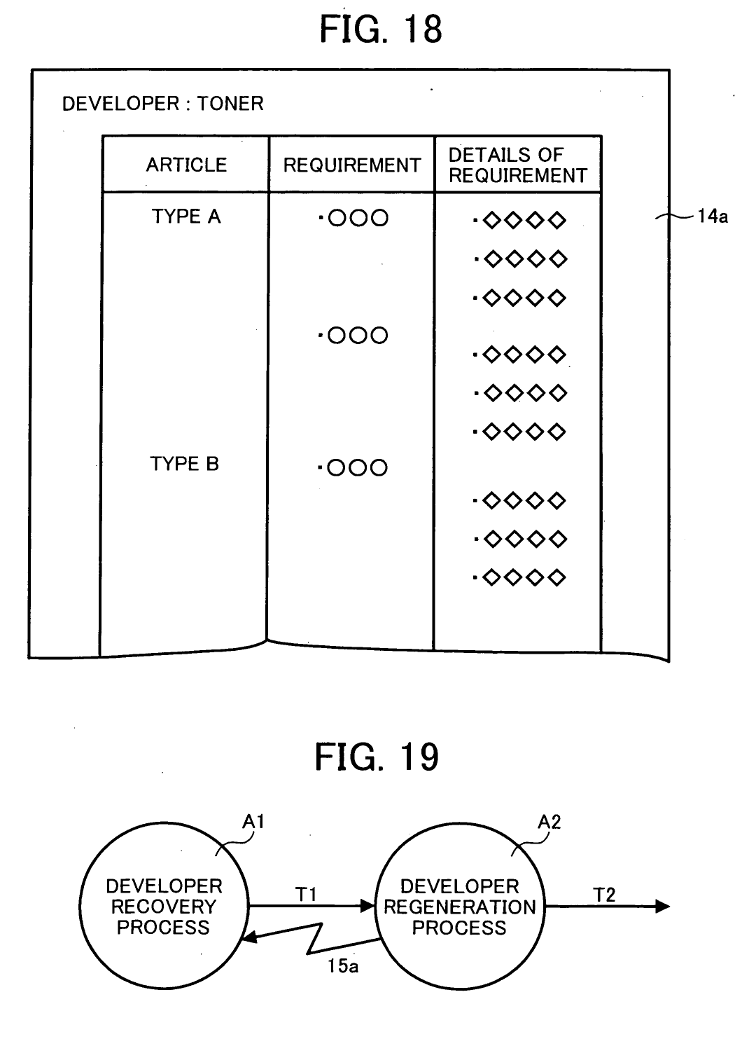

Table 14a in FIG. 18 shows recovered developer acceptance quality reference information 13a as an example of information to be transmitted. Table 14a is prepared, for example, on the personal computer 143 in the developer regeneration process A2 and is communicated via the network 144. Table 14a is checked on the screen of the personal computer 142 in the developer recovery process A1.

Another example of information communication may be mentioned in which those printers 145 and 146 are connected as output means to the personal computers to print on a recording medium such as a paper sheet information mutually communicated via the network 144, thereby enabling the information to be checked. For example, in the case of recovered developer acceptance quality reference information 13a, Table 14a communicated via the network 144 may be output in advance onto a paper sheet by the printer 145 in the developer recovery process A1 and the information may be checked on the print sheet. Output means other than the printers, e.g., facsimile machines may be connected to the network 144 to receive the information and output Table 14a onto a sheet.

### 11th Embodiment

FIG. 19 shows another example of information communication for smoothly performing recycling. This example in this embodiment is an example of information communication for performing production in accordance with a production schedule. For production of a desired amount of regenerated developer T2 in the developer regeneration process A2, a desired amount of recovered developer T1 is required. Information on these required amounts may be communicated as recovered developer accepted amount information 15a from the developer regeneration process A2 to the developer recovery process A1. For example, the amount of developer to be used is transmitted on a monthly basis.

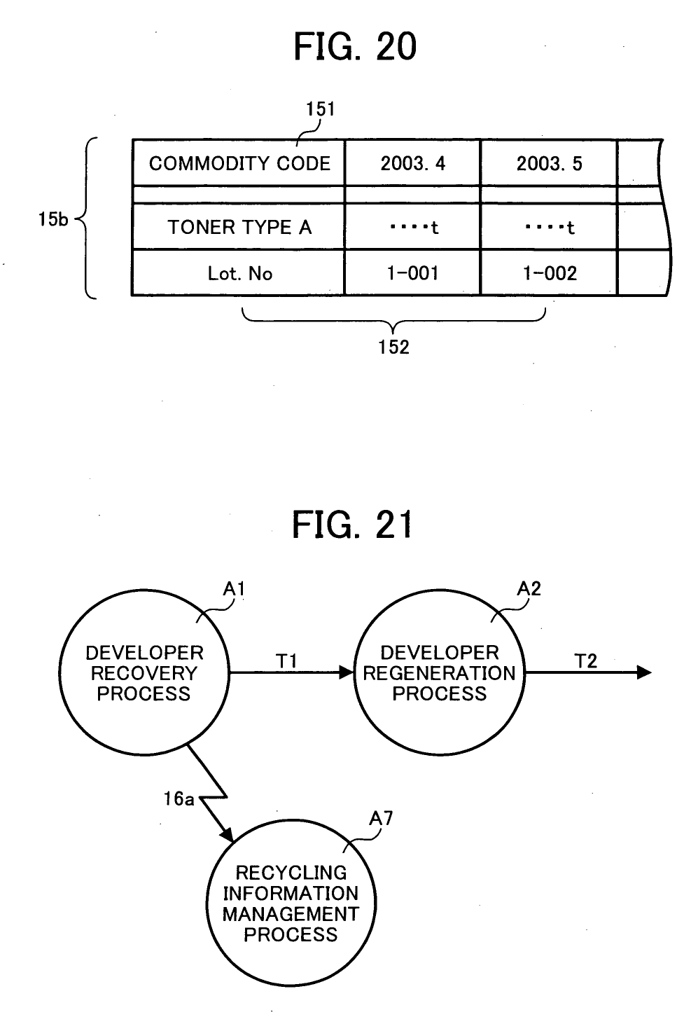

Table 15b in FIG. 20 shows recovered developer accepted amount information 15a as an example of this information communication form. Table 15b is prepared on the personal computer 143 (see FIG. 17) in the developer regeneration process A2 and is communicated via the network 144. The contents of Table 15b are checked on the personal computer 142 in the developer recovery process Al. In Table 15b, the amount of toner to be purchased is entered, for example, on a monthly basis, as shown in FIG. 20. Further, an identification code, e.g., a commodity code 151 may be attached to the recovered developer and a lot No. 152 may also be attached on a monthly basis for example, thereby facilitating management. Management of this information can be performed on the personal computers 142 and 143.

### 12th Embodiment

FIG. 21 shows an example of an arrangement for enabling the state of execution of recycling (information on the state) to be easily grasped. In this embodiment, as shown in FIG. 21, information on processing of a developer including that on the developer sent to the developer regeneration process A2 is managed as recycling execution information 16a by an information processor, e.g., personal computer 142 in the developer recovery process A1. More specifically, the recycling execution information 16a includes data on the kind and the amount of recovered developer T1 recovered in the developer recovery process A1, data on the kind and the amount of a portion of the recovered developer T1 supplied to the developer regeneration process A2 (corresponding to the data in Table 15b), and data on the kind (according to classification of material recycles or the like)/amount of recycling processing for details of processing means in the case of processing of the developer in a process different from processing in the developer regeneration process A2. The toner recycling execution information 16a further includes recycle ratio data, material recycling execution ratio data, energy recovery execution ratio data, etc., computed from the above-described sorts of data. Computation of these sorts of data may be executed on the personal computers 142 and 143.

For storage and management of data, a recycling information management process A7 may be further provided. If the recycling information management process A7 is provided, information can be collectively managed in the recycling information management process A7 even in a case where a plurality of developer recovery processes A1 are distributed.

While the embodiments have been described by assuming that the developer is a single toner or a two-component developer having a toner and a carrier, the kind of developer is not limited to these. Needless to say, any of various kinds of ink used in printing machines and ink-jet printers may be treated as an object to be recovered and recycled. While in each of the above-described embodiments a developer such as a toner is mainly treated as an object to be recycled, a container such as a toner bottle or a cartridge provided as a product for containing the developer may be treated as an object to be recycled.

### 13th Embodiment

Paper sheets to be treated as an object to be recycled in each of embodiments described below are limited to paper sheets on which images (characters, figures, etc.) are formed by using a toner as a developer in an image forming apparatus such as a copying machine, a facsimile machine or a laser printer. Paper sheets on which images are formed by a material other than toners are not included in those on which images are formed by a developer and which are recycled in accordance with the present invention.

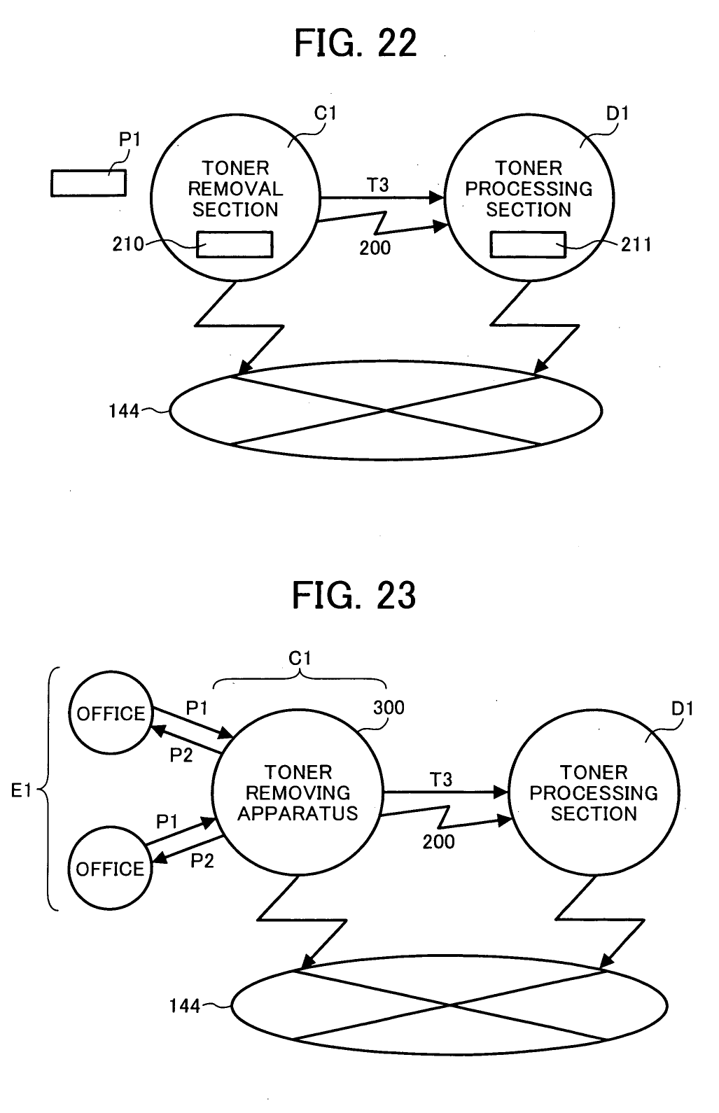

In this embodiment, as shown in FIG. 22, a toner is removed from paper sheets used in an office (hereinafter referred to as “used paper sheet P1”) by a toner removal section C1 provided as a developer removal section. After removal of the toner, used paper sheets P1 are obtained as recycled paper and recycled by being again used in the office. On the other hand, the removed toner (hereinafter referred to as “recovered toner C3”) is temporarily accommodated in a certain amount in the toner removal section C1. Toner recycling processing request information 200 is thereafter communicated from the toner removal section C1 to a toner processing section D1 provided as a developer processing section, and the toner is transported to the toner processing section D1. The toner undergoes recycling processing in the toner processing section D1.

For communication of toner recycling processing request information 200, each of the toner removal section C1 and the toner processing section D1 may have a personal computer provided as information processing means and communication means, or a device used in each of the toner removal section C1 and the toner processing section D1 may incorporate a board-type computer (not shown). In this embodiment, personal computers 210 and 211 are provided, as shown in the figure. For storage of data relating to toner recycling processing request information 200, therefore, effective use may be made of a hard disk or the like and a memory of a board-type computer provided in the personal computers 210 and 211. The toner removal section C1 and the toner processing section D1 are connected to a network 144. For example, network-compatible printers 145 and 146 shown in FIG. 17 may be connected to the network 144 to be used as a network printer and made to function as an output means for outputting various sorts of data onto a paper sheet.

Data storage may be performed on paper by using a well-known facsimile machine (not shown) without using personal computers 210 and 211 or the board-type computer as information processing and communication means.

### 14th Embodiment

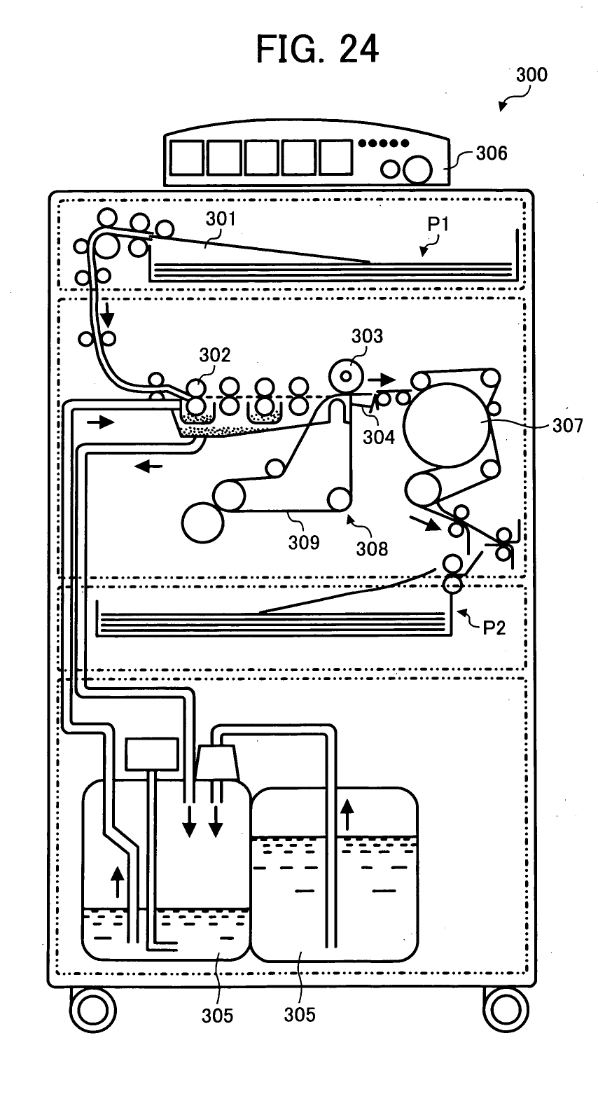

In this embodiment, as shown in FIG. 23, a toner removing apparatus 300 is provided as a developer removing apparatus corresponding to toner removal section C1. FIG. 24 shows the construction of the toner removing apparatus 300. As shown in FIG. 24, the toner removing apparatus 300 has a sheet feed section 301, a solution supply and application section 302, a separating section 303, a toner accommodation section 304, a separating solution tank 305, an operating section 306, a finishing section 307 and a sheet discharge section 308 having a separating member 309.

The operation of this toner removing apparatus 300 will be described. When used paper sheets P1 are produced in office E1, the used paper sheets P1 are first set in the sheet feed section 301. The sheet feed section 301 feeds used paper sheets P1 one by one into the apparatus. On the other hand, a predetermined chemical solution (separating solution) is supplied from the separating solution tank 305 to the solution supply and application section 302. In the solution supply and application section 302, the separating solution supplied from the separating solution tank 305 is applied to the used paper sheet P1. Fibers of the sheet are thereby swollen so that the bonding strength of the toner is reduced. In the separating section 303, the toner is pressed against the separating member 309 while being heated. The toner is thereby transferred to the separating member 309. That is, at this point in time, the toner is separated from the used paper sheet P1.

In the toner accommodation section 304, the toner transferred to the separating member 309 is removed to be accommodated in an accommodation portion (not shown) in the apparatus. In the finishing section 307, moisture in the sheet and a curl of the sheet are removed. In the sheet discharge section 308, sheets P2 obtained after moisture and curl removal are stocked. Through the operating section 306, apparatus operating instructions are input and information of operations is displayed. This arrangement makes it possible to obtain newly-usable recycled paper sheets P2 by removing from fed used paper sheets P1 the toner forming images on the sheets.

In this embodiment, the toner removing apparatus 300 is movable. More specifically, the toner removing apparatus 300 may be constructed integrally with a motor vehicle provided as a mobile or transport means, or may be mounted in a motor vehicle. In such a case, however, the toner removing apparatus 300 is owned not on the office E1 side where used paper sheets P1 and recycled paper sheets P2 are used but by a company or person who recycles used paper sheets P1 (paper recycler). In such a case, when used paper sheets P1 are accumulated, a recovery request is transmitted from office E1 by telephone, a facsimile machine or some other means such as electronic mail using a computer. At the recovery request, the toner removing apparatus 300 is moved to the corresponding office E1 to perform the above-described paper sheet recycling processing.

Ordinarily, a paper recycler makes business contracts with a plurality of offices E1. In such a case, the paper recycler may simultaneously receive requests from a plurality of offices E1. In such an event, the toner removing apparatus 300 may be moved from one office E1 to another to perform paper recycling processing.

A toner accommodation capacity measuring sensor and an information processing and communication board (neither shown) are incorporated in the toner removing apparatus 300. The toner accommodation capacity measuring sensor is provided in the toner accommodation section 304. The toner accommodation capacity measuring sensor measures the amount of toner accumulated by the toner removing apparatus 300 and transmits the measurement result to the information processing and communication board. The information processing and communication board compares an accommodation limit value of the toner removing apparatus 300 input in advance and the output from the sensor (current accommodation capacity). When the current accommodation value approaches the limit value, the information processing and communication board transmits toner recycling processing request information 200. Simultaneously, the operating section 306 displays information that the accommodation limit is approached.

After transmission of toner recycling processing request information 200, the toner removing apparatus 300 moves to the toner processing section D1. After the move, the toner is taken out from the toner accommodation section 304 of the toner removing apparatus 300, and recycling processing is performed in the toner processing section D1.

### 15th Embodiment

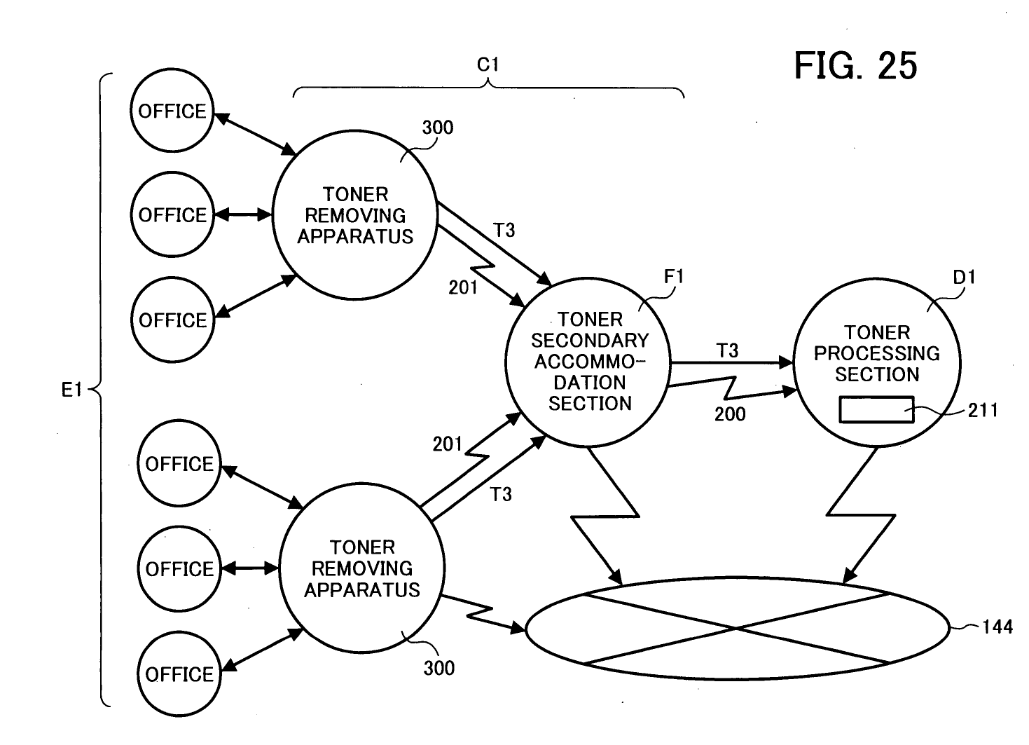

This embodiment is an example of an arrangement for improving the transport efficiency in a case where the fourteenth embodiment is arranged over a wide area. In this embodiment, as shown in FIG. 25, a toner secondary accommodation section F1 is provided as a developer secondary accommodation section. When one toner removing apparatus 300 collects an amount of toner close to a toner accommodation limit, the apparatus transmits accommodation request information 201 to the toner secondary accommodation section F1 to request this section to accommodate the toner in the apparatus. After this transmission, the toner removing apparatus 300 moves by itself to the toner secondary accommodation section F1. The toner secondary accommodation section F1 then accommodates the toner collected by the toner removing apparatus 300. The toner secondary accommodation section F1 receives similar accommodation request information 201 from a plurality of toner removing apparatuses 300 existing near the toner secondary accommodation section F1. As a result, a large amount of toner is accommodated in the toner secondary accommodation section F1.

When the amount of toner accommodated in the toner secondary accommodation section F1 becomes close to an accommodation limit value, the toner secondary accommodation section F1 transmits toner recycling processing request information 200 to the toner processing section D1 to request the same to process the toner, and transports the recovered toner T3 to the toner processing section D1. It is desirable from the viewpoint of itineration efficiency that each of toner removing apparatuses 300 itinerating from one office E1 to another be in the form of a small truck or the like. However, if each toner removing apparatus 300 is small, its toner accommodation capacity is reduced.

However, it is thought that the transport efficiency is improved if the toner is temporarily collected in the toner secondary accommodation section F1 and if the toner is transported from the toner secondary accommodation section F1 to the toner processing section D1 by using a large truck or the like, as in the present embodiment. In such a case, however, it is important that the toner secondary accommodation section F1 be placed so as to have a sufficiently small distance to each toner removing apparatus 300 or so as to be closer to each toner removing apparatus 300 at least in comparison with the toner processing section D1.

### 16th Embodiment

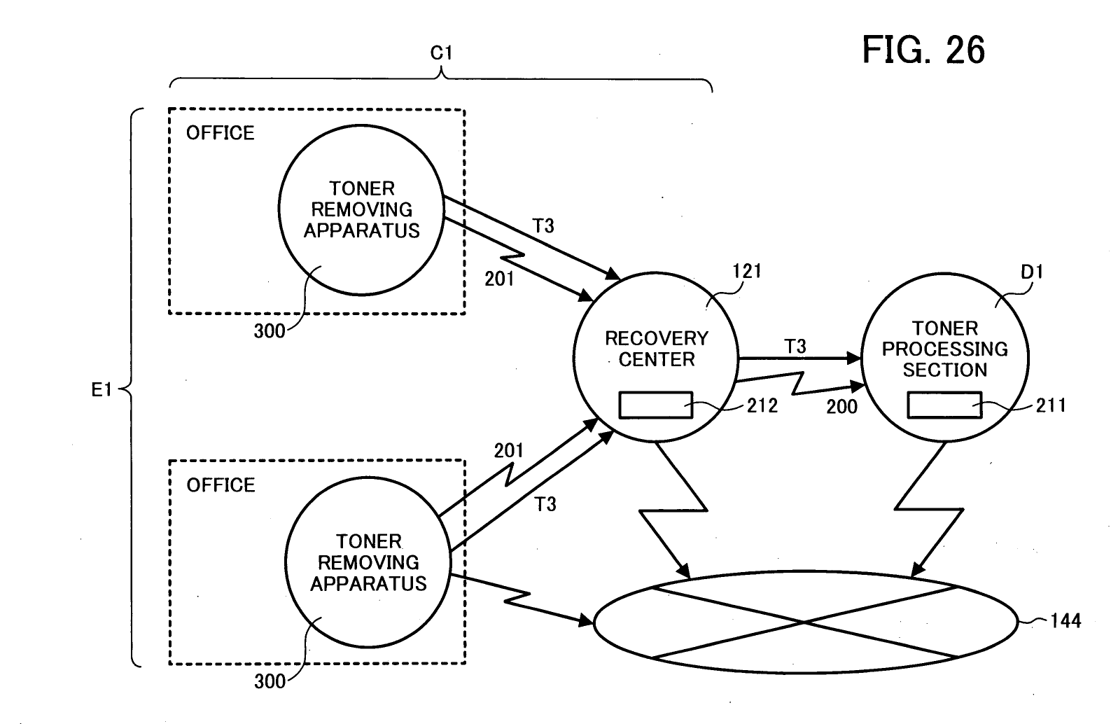

As shown in FIG. 26, this embodiment is an example of an arrangement in which the toner removing apparatus 300 shown in FIG. 25 belongs to each office E1 and is placed in the office E1. In a case where the toner removing apparatus 300 is provided in each office E1, it cannot move by itself like those in the above-described examples. Therefore, when the amount of toner in the toner removing apparatus 300 is increased, a need arises for a serviceperson to go to the office E1 and recover the toner. More specifically, the toner removing apparatus 300 collecting the toner in an amount close to the toner accommodation limit transmits accommodation request information 201 to the recovery center 121 to request the same to accommodate the toner in the apparatus. The recovery center 121 receives the accommodation request information 201 and thereafter recovers the toner by using a transport means such as a truck and making the transport means move to the office E1 where the toner removing apparatus 300 exists. At the time of recovery, other used office products (a copying machine, etc.,) and used supplies (used toner, a used cartridge, etc.) may also be recovered. In a case where there are a plurality of offices E1 where toner removing apparatuses 300 are installed, recovery from the offices E1 transmitting accommodation request information 201 is performed in an itinerating manner.

The toner collected as described above is temporarily accommodated in the recovery center 121. The recovery center 121 accommodates the toner from all the offices E1 existing near the recovery center 121 and having the toner removing apparatuses 300 installed therein. A large amount of toner is therefore accommodated in the recovery center 121.

When the amount of toner accommodated in the recovery center 121 becomes close to the accommodation limit, the recovery center 121 transmits toner recycling processing request information 200 to the toner processing section D1 and transports the toner to the toner processing section D1 by using a large truck or the like. The toner supplied from the recovery center 121 to the toner processing section D1 at this time may include a toner recovered as a used supply as well as the toner separated from used paper sheets P1 by the toner removing apparatus 300.

When the toner is transported from the recovery center 121 to the toner processing section D1, lot numbers for processing management may be attached to lots to be sent, thereby enabling quality management, processing amount management, etc., in toner recycling processing. Lot numbers can be easily attached by using a label printer, a bar code printer or the like. Further, in the recovery center 121, execution management of processings in embodiments described below may be performed. For example, data on the material recycle ratio, the raw material regeneration rate and the energy recovery rate may be computed with reference to the above-mentioned lot numbers and details of processing in the toner processing section D1, thereby enabling data management. To enable such data management, a personal computer 212 having communication functions may be provided as a data processing means in the recovery center 121. This personal computer 212 is connected to the network 144 to be able to communicate with the personal computer 211 in the toner processing section D1. Each toner removing apparatus 300 is also connected to the network 144 to be able to communicate with other terminal devices connected to the network 144.

### 17th Embodiment

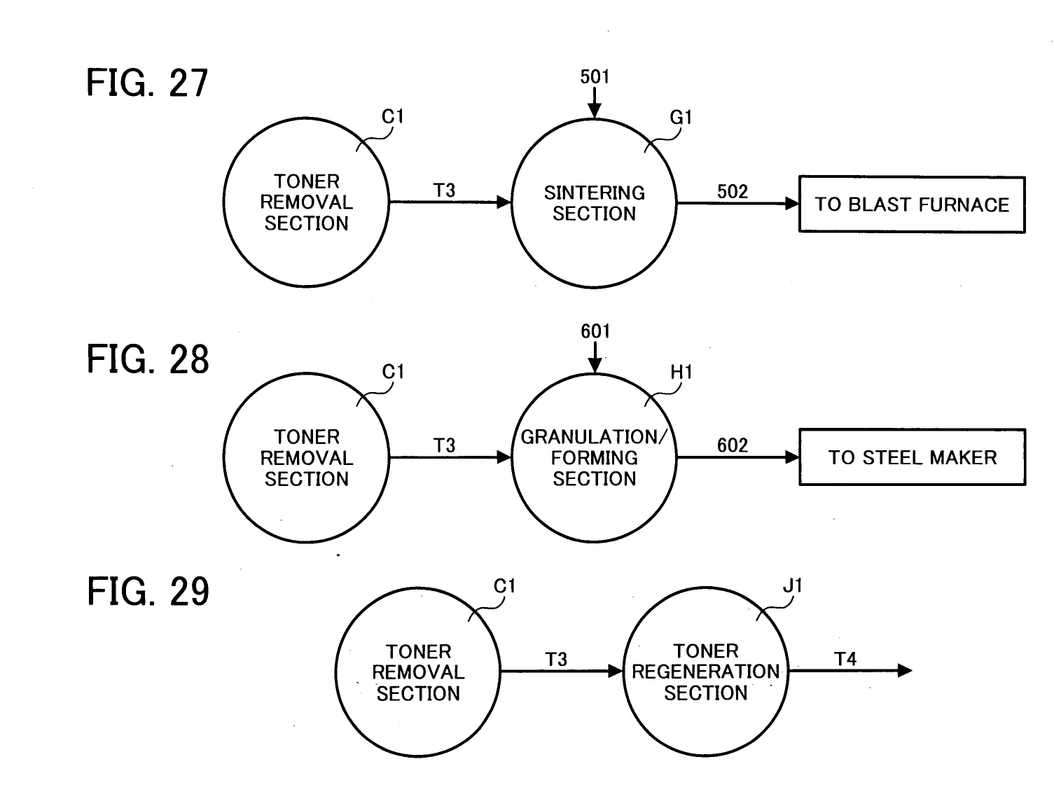

A concrete example of recycling processing in the toner processing section D1 according to this embodiment will be described with reference to FIG. 27. FIG. 27 shows an example of a method in which ironworks are effectively utilized and a material is charged in a sintering section G1 for performing a sintering process in a steel production process. In this example, effective use is made of the waste toner processing method and apparatus described in Japanese Patent Laid-Open No. 2001-3063 referred to above. More specifically, recovered toner T3 is mixed in a steel material 501 containing iron ore and powder coke in a special-purpose mixer. The steel material 501 in which the toner is mixed is sintered by a sintering machine used as the sintering section G1. Consequently, the iron component in the toner mixed in the steel material 501 is effectively utilized as an iron source. Also, part of a resin in the toner is combusted to be effectively utilized as an iron ore reducer, i.e., a substitute for powder coke. After sintering in the sintering section G1, the sintered steel material 502 is conveyed to a blast furnace (not shown) in the ironworks to be used for pig iron making.

### 18th Embodiment

In this embodiment, as shown in FIG. 28, recovered toner T3 collected by the toner removal section C1 is used as a raw material together with aluminum ash produced by aluminum refining or aluminum foil 601 or the like for granulation/forming in a granulation/forming section H1 in a granulation/forming process, thereby making a steel-making flux 602 as a sub-raw material for pig iron making. The steel-making flux 602 thus made is transported to a steel maker.

In the granulation/forming section H1, the recovered toner T3 functions as a binder for the steel-making flux 602. In use as a binder, the toner does not reduce the quality of the steel-making flux 602 since it does not react with aluminum metal or aluminum nitride which is an aluminum-based compound. Also, the toner has high formability and, even when added to molten pig iron or molten steel in a steel manufacture process, it does not worsen a working environment as does tar or pitch conventionally used as a binder. Thus, the recovered toner T3 is markedly suitable for use as a binder in terms of quality.

Further, the toner is suitable for use as a binder in terms of production cost. More specifically, at the time of granulation/forming in the granulation/forming section H1, the object to be granulated or formed, including the recovered toner T3, undergoes frictional compression to unavoidably generate heat. A binder resin which is a principal component of the toner has a suitable softening point such as to have a good fixing characteristic, i.e., good thermal fusibility and low viscosity, under such a condition. Therefore, there is no need to provide an additional heating means. For this reason, it is markedly preferable to use the recovered toner T3. Moreover, the toner is finely granular and has a large surface area relative to the total volume, hence, a large friction surface, so that the frictional compression efficiency is high and the thermal conductivity and the flowability are increased. Therefore, the heating efficiency is further improved.

The material granulated or formed for use as steel-making flux 602 by granulation/forming in the granulation/forming section H1 can be obtained in any form, e.g., in the form of granules, pellets or briquettes according to use. Possible forming methods are roughly divided into wet types (a pelletizer and a low-pressure briquette machine) and dry types (a high-pressure briquette machine and a rotary press machine) (neither shown). However, it is preferable to use a dry-type forming machine in order to avoid the detrimental effects of reaction of aluminum metal or aluminum nitride which is a principal component of the steel-making flux 602, with water. Further, the productivity is higher when a high-pressure briquette machine is used than when a rotary press machine is used. When the productivity is high, the production cost can be controlled. Therefore it is preferable to use a high-pressure briquette machine in actual operation. In actuality, the roll pressing force of a high-pressure briquette machine in ordinary operation is 10 to 20 Ton/cm² and the roll die temperature is increased to 60 to 80° C. even if no special heating device is provided. Therefore, if the recovered toner T3 has a melting point of about 60° C. and if forming heat is utilized at the time of forming, it is ordinarily possible to omit heating after forming.

### 19th Embodiment

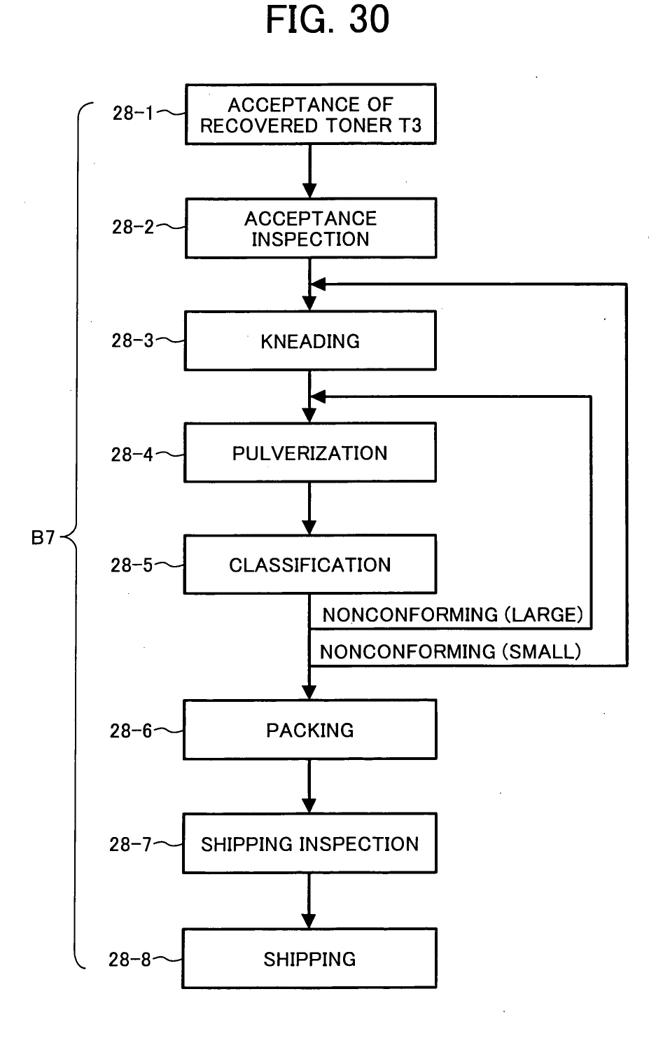

FIG. 29 shows an example of a system for executing the recycling method of this embodiment. This system is characterized in that the toner recovery process B1 is executed in the toner removal section C1 and the regenerated toner T4 for enabling the recovered toner T3 collected in the toner removal section C1 to be again used on the market is produced in a toner regeneration section J1 in which the toner regeneration process B2 is executed, by using the recovered toner T3 as a raw material. In this embodiment, full use is made of the recycled recovered toner T3 as the regenerated toner T4. Therefore, full use can be made of the essential functions of the toner after recycling.

FIG. 30 shows a toner regeneration process B7 executed in the toner regeneration section J1. In this toner regeneration process B7, steps described below are performed. First, in STEP 28-1, recovered toner T3 is accepted. In STEP 28-2, acceptance inspection is performed. In this step, an inspection in accordance with an acceptance criterion set in advance is made. For example, an inspection as to whether or not dust or the like is contained is performed by a desired inspection means. In STEP 28-3, kneading is performed by using a kneading machine such as a load mill (not shown). In STEP 28-4, pulverization for again making the kneaded toner finely granular is performed with a well-known pulverizer such as a hammer mill or a jet mill. STEP 28-4 may have several roughly-pulverizing and finely-pulverizing stages. In STEP 28-5, classification for selecting only particles of a desired size is performed. Particles of the pulverized toner having sizes out of a prescribed range are removed. This classification is performed by a means conventionally used, e.g., pneumatic classification. Nonconforming particles of larger sizes are returned to STEP 28-4 to again undergo pulverization. Nonconforming particles of smaller sizes are returned to kneading in STEP 28-3 to achieve full use.

In STEP 28-6, the classified toner is packed in a container. In STEP 28-7, an inspection for checking components in the packed toner and a shipping inspection for checking the amount of packing or the like are performed. In STEP 28-8, the toner is shipped. These steps are basically the same as those in a pulverization process of the conventional art for producing a new toner.

The present invention has advantages described below.

(1) Full use as a developer is again made of used developers on the market no matter what kind of toner and kind of carrier are used. Full use of the essential functions of the developer is thereby made to improve the functionality and effectiveness unlike a use of a sintering process of the conventional art. No portion of the developer is wasted and the economical additional value of the recovered developer can be improved to make the recovered developer valuable, thus enabling a continuable recycling activity.

(2) Quality characteristics required in the developer regeneration process and a production schedule can be grasped. Therefore, toner recycling can be smoothly performed without quality complaints and overstock.

(3) In consideration of the physical distribution efficiency, it is desirable that the developer recovery process and the developer regeneration process be performed in remote places. Even if they are performed in remote places, necessary information can be communicated speedily and accurately. Further, the information can be stored and referred to when necessary.

(4) Information about environmental protection can be grasped and managed to achieve smooth toner recycling.

(5) Each of a toner removal section such as a toner removing apparatus which removes a toner and a toner regeneration section capable of toner recycling processing is provided with information processing and communication means to enable recognition of toner generation and communication as to toner generation. Recycling of a toner used for images on paper sheets is thereby enabled while the conventional recycling by producing recycled paper is being performed, thus contributing to environmental protection more effectively.

Various modifications will become possible for those skilled in the art after receiving the teachings of the present disclosure without departing from the scope thereof.

What is claimed is:

1. A recycling method in which a developer is recovered from a product used on the market and is processed, said method comprising:
a developer recovery step of recovering the used developer from the market; and
a developer regeneration step of making the developer recovered in the developer recovery step again usable on the market.

2. The method as claimed in claim 1, wherein the developer comprises a toner.

3. The method as claimed in claim 2, wherein the developer regeneration step includes packing the recovered toner in a container without processing the recovered toner into toner particles.

4. The method as claimed in claim 2, wherein the developer regeneration step includes mixing the recovered toner in a desired proportion in a newly produced toner without processing the recovered toner into toner particles, and packing the mixture toner in a container.

5. The method as claimed in claim 4, wherein the developer regeneration step includes uniformizing a newly produced toner and the recovered toner with a mixer which mixes the newly produced toner and the recovered toner, and packing the toners in the container.

6. The method as claimed in claim 2, wherein the developer regeneration step includes packing the recovered toner in a container after kneading, pulverizing and classifying the recovered toner.

7. The method as claimed in claim 2, wherein the developer regeneration step includes at least one of the steps of:
performing kneading, pulverization, classification and packing of the recovered toner;
performing the kneading after mixing a new toner raw material in a desired proportion;
performing the pulverization after mixing in a desired proportion the new toner raw material separately kneaded;
performing the classification after mixing in a desired proportion the new toner raw material separately kneaded and pulverized; and
performing the packing after mixing in a desired proportion a new toner.

8. The method as claimed in claim 2, wherein the developer regeneration step includes packing the recovered toner in a container after dissolving, polymerizing and classifying the recovered toner.

9. The method as claimed in claim 2, wherein the developer regeneration step includes at least one of the steps of:
performing dissolution, polymerization, classification and packing of the recovered toner;
performing the dissolution after mixing a new toner raw material in a desired proportion;
performing the polymerization after mixing in a desired proportion the new toner raw material separately dissolved;
performing the classification after mixing in a desired proportion the new toner raw material separately dissolved and polymerized; and
performing the packing after mixing in a desired proportion a new toner.

10. The method as claimed in claim 1, wherein the developer is a two-component developer in which a toner and a carrier are mixed.

11. The method as claimed in claim 10, wherein the developer regeneration step includes packing the recovered two-component developer in a developer container.

12. The method as claimed in claim 10, wherein the developer regeneration step includes separating the recovered two-component developer into the toner and the carrier, and performing regeneration processing on each of the separated toner and carrier.

13. The method as claimed in claim 1, wherein the developer comprises printing ink or ink for an ink jet type of printer.

14. The method as claimed in claim 1, wherein the developer recovery step is performed in a recycling center where a used developer is collected by being separated from a product having the used developer, a unit in the product or a supply container in the product.

15. The method as claimed in claim 14, wherein the recycling center collects developers separately from each other by separating the developers with respect to the kinds of the developers.

16. The method as claimed in claim 1, wherein the developer recovery step is performed in a recovery center having the function of recovering from the market a product having a used developer, a unit in the product or a supply container in the product, and in a recycling center having the function of separating a used developer from an article recovered in the recovery center.

17. The method as claimed in claim 16, wherein the recovery center collects developers separately from each other by separating the developers with respect to the kinds of the developers.

18. The method as claimed in claim 1, wherein the developer recovery step includes receiving, by communication means, recovered developer acceptance quality reference information transmitted by the same communication means from the developer regeneration step, and recovering the developer satisfying a quality condition corresponding to the received recovered developer acceptance quality reference information.

19. The method as claimed in claim 18, wherein the communication means comprises an information processing device capable of communication via the Internet.

20. The method as claimed in claim 18, wherein each of the developer recovery step and the developer regeneration step includes storing transmitted/received information in data storage means, and outputting by output means at least data stored in the data storage means.

21. The method as claimed in claim 1, wherein the developer recovery step includes receiving, by communication means, recovered developer accepted amount information transmitted by the same communication means from the developer regeneration step, and supplying the developer regeneration step with a necessary amount of the recovered developer corresponding to the received recovered developer accepted amount information.

22. The method as claimed in claim 21, wherein the developer recovery step includes attaching an identification number to the recovered developer to be supplied to the developer regeneration step, the identification number being selected according to the kind of the recovered developer to be supplied to the developer regeneration step.

23. The method as claimed in claim 22, wherein the developer recovery step includes attaching, on the basis of the recovered developer accepted amount information, a manufacture code to the recovered developer to be supplied to the developer regeneration step with respect to each supply lot when a necessary amount of the recovered developer is supplied to the developer regeneration step.

24. The method as claimed in claim 21, wherein the communication means comprises an information processing device capable of communication via the Internet.

25. The method as claimed in claim 21, wherein each of the developer recovery step and the developer regeneration step includes storing transmitted/received information in data storage means, and outputting by output means at least data stored in the data storage means.

26. The method as claimed in claim 21, wherein the developer recovery step includes a recycling information management step of computing, as recycling execution data, recycle ratio data, material recycle ratio data and energy recovery rate data from data on the kinds and amounts of developers collected from the market, the kind and amount of the recovered developer supplied to the developer regeneration step, details of means other than supply to the developer regeneration step in a case where the recovered developer is processed by the other means, and the kind and amount of the recovered developer processed by the other means.

27. The method as claimed in claim 26, wherein the recycling information management step includes storing and managing the recycling execution information transmitted from the developer recovery step by the communication means.

28. A recycling system in which used paper sheets used on the market are processed, said system comprising:
a developer removal section which has an information processing function and a communication function, and which removes a developer attached to the used paper sheets, and accommodates the removed developer; and
a developer processing section which has an information processing function and a communication function, and which performs recycling processing on the developer accommodated in said developer removal section,
wherein said developer removal section makes a determination as to the need for recycling processing on the developer on the basis of the amount of accommodated developer, and transmits recycling processing request information to said developer processing section when determining that there is a need for recycling, and said developer processing section performs recycling processing on the developer after receiving the recycling processing request information from said developer removal section.

29. The system as claimed in claim 28, wherein said developer removal section comprises a developer removing apparatus having information processing means of processing various sorts of information, communication means of transmitting the results of processing performed by said information processing means, developer removal means of removing the developer from the used paper sheets, and developer accommodation means of accommodating the removed developer.

30. The system as claimed in claim 29, wherein said developer removing apparatus is movable and said developer removing apparatus itself moves to transport the accommodated developer to said developer processing section after said developer removing apparatus has transmitted the recycling processing request information.

31. The system as claimed in claim 29, wherein each of said communication means comprises at least one of a device capable of communicating via a network and a facsimile machine.

32. The system as claimed in claim 29, further comprising data storage means of storing information received or transmitted by each section, and output means of outputting at least data stored in the data storage means.

33. The system as claimed in claim 28, wherein said developer removal section comprises a developer removing apparatus having information processing means of processing various sorts of information, communication means of transmitting the results of processing performed by said information processing means, developer removal means of removing the developer from the used paper sheets, and developer accommodation means of accommodating the removed developer, and a developer secondary accommodation section which has information processing and communication functions, and which performs secondary accommodation of the developer accommodated in said developer removing apparatus,
wherein said developer removing apparatus makes a determination as to the need for secondary accommodation on the basis of the amount of the developer accommodated in said developer accommodation means, and transmits accommodation request information to said developer secondary accommodation section when determining that there is a need for secondary accommodation, and
wherein said secondary accommodation section accommodates the developer accommodated in said developer removing apparatus after receiving the accommodation request information, makes a determination as to the need for recycling processing on the developer on the basis of the amount of the developer accommodated by secondary accommodation, and transmits recycling processing request information to said developer processing section when determining that there is a need for recycling processing.

34. The system as claimed in claim 33, wherein said developer removing apparatus is movable and said developer removing apparatus itself moves to transport the developer accommodated in said developer accommodation means to said developer secondary accommodation section after said developer removing apparatus has transmitted the accommodation request information.

35. The system as claimed in claim 33, wherein said developer secondary accommodation section comprises movable recovery means, and recovers the developer accommodated in said developer removing apparatus by using said recovery means when said developer removing apparatus transmits the accommodation request information.

36. The system as claimed in claim 35, wherein said developer secondary accommodation section comprises a recovery center which recovers used products and supplies, and said recovery means comprises transport means, said transport means moving and recovering the developer from said developer removing apparatus on the basis of a request from said recovery center and, after temporary storage of the developer, transporting the developer to said developer processing section.

37. The system as claimed in claim 36, wherein said recovery center has an identification function for attaching an identification number on a supply unit basis to the developer to be supplied to said developer processing section.

38. The system as claimed in claim 36, wherein said recovery center comprises a processing detail determination section which determines to which one of processing items: material recycling, raw material regeneration, and energy recovery the recycling processing performed in said developer processing section corresponds, a data detection section which detects supply amount data on the amount of the developer supplied to said developer processing section, and a recycling information management section which computes the recycle rate from the supply amount data detected by said data detection section and a processing detail determined by said processing detail determination section, with respect to each processing item in the recycling processing on the developer supplied to said developer processing section.

39. The system as claimed in claim 33, wherein each of said communication means comprises at least one of a device capable of communicating via a network and a facsimile machine.

40. The system as claimed in claim 33, further comprising data storage means of storing information received or transmitted by each section, and output means of outputting at least data stored in the data storage means.

41. The system as claimed in claim 28, wherein said developer processing section comprises a sintering section which mixes the recovered developer in a raw material to be sintered and sinters the raw material.

42. The system as claimed in claim 28, wherein said developer processing section comprises a granulation/forming section which performs granulation or forming by mixing the recovered developer and a material including a metal powder.

43. The system as claimed in claim 28, wherein said developer processing section comprises a developer regeneration section which processes the recovered developer to make the recovered developer again usable on the market.
